(19) United States
(12) Patent Application Publication
(10) Pub. No.: US 2026/0179384 A1
(43) Pub. Date: Jun. 25, 2026

(54) SMART OUTDOOR SYSTEM

(71) Applicant: Angarak, Inc., San Diego, CA (US)

(72) Inventors: Sai Akhil Reddy KONAKALLA, San Diego, CA (US); Dominique E. MEYER, San Diego, CA (US)

(73) Assignee: Angarak, Inc., San Diego, CA (US)

(21) Appl. No.: 19/128,973

(22) PCT Filed: Nov. 6, 2023
(86) PCT No.: PCT/US2023/078849

§ 371 Date: May 9, 2025

Related U.S. Application Data
(60) Provisional application No. 63/424,571, filed on Nov. 11, 2022.

(51) Int. Cl. G06V 20/52; G06T 3/18; G06T 7/246; G06T 7/32; G06V 10/10; G06V 10/82; G06V 10/84; G06V 10/96; G06V 40/10; G06V 40/20

(52) U.S. Cl. CPC G06V 20/52; G06T 3/18; G06T 7/246; G06T 7/32; G06V 10/16; G06V 10/82; G06V 10/85; G06V 10/96; G06V 40/10; G06V 40/20; G06T 2207/20084; G06T 2207/20212; G06T 2207/30196; G06T 2207/30232

(57) ABSTRACT

Disclosed herein are systems and methods for image-based monitoring of a backyard space. In some embodiments, the method comprises receiving, by a processing device, image data corresponding to an area, the image data including a number of frames of the area, each of the number of frames having a perspective. In some embodiments, the method comprises warping each of the plurality of frames to produce a plurality of transformed frames each having a top view, combining the plurality of transformed frames to produce a composite frame, determining, based on the composite frame, a state associated with a characteristic of the area, and determining a processing queue including a routine based on the state. In some embodiments, the method comprises executing the routine.

### CROSS-REFERENCE TO RELATED APPLICATIONS

This application claims the priority benefit of U.S. Provisional Application No. 63/424,571 filed on Nov. 11, 2022, the disclosure of which is hereby incorporated herein by reference in its entirety.

### FIELD

This disclosure generally relates to an image-based monitoring system. More specifically, this disclosure relates to image-based systems and methods for monitoring and deriving analytics in an outdoor space.

### BACKGROUND

In some contexts it may be desirable to monitor a space, such as a backyard space. For example, a user may wish to monitor who travels through a backyard space for security reasons. As another example, a user may wish to monitor a parking space in front of their house to prevent others from tampering with vehicles parked in the parking space. Spaces such as backyard spaces may include features such as a swimming pool that present challenges for monitoring the space. For example, a user may wish to monitor a swimming pool for events (e.g., dangerous behavior, a drowning swimmer, a dirty pool, etc.).

### BRIEF SUMMARY

It may be difficult to monitor a space manually. Solutions exist to reduce a need for manual monitoring, however they may be costly (e.g., high hardware cost, high cost of installation, long installation time), lack an ability to contextualize specific events (e.g., infer unknown information about the space from known information about the space), not sufficiently accurate (e.g., high false alarm rates), or a combination thereof. Moreover, existing solutions may be discrete and may lack an ability to integrate with the various devices present in a backyard space (e.g., pool pumps, automatic awning systems, sprinkler systems, lighting systems, automatic pool covers, etc.). For example, a first existing solution may control a sprinkler system and a second existing solution may control a pool pump and the first and second existing solutions may be unable to interact (e.g., communicate instructions, etc.).

Disclosed herein are systems and methods for image-based monitoring of a space.

One implementation of the present disclosure is a method for monitoring a backyard space. In some embodiments, the method includes receiving, by a processing device, image data corresponding to a swimming pool area, determining, by the processing device based on the image data, a state associated with a characteristic of the swimming pool area, determining, by the processing device based on the state, a processing queue including a routine based on the state, and/or executing the routine.

In some embodiments, the method includes generating, by executing the routine, an analytic describing an operational characteristic of the swimming pool area. In some embodiments, the analytic is based on the state of the swimming pool area. Advantageously, the smart outdoor system may control the backyard space based on the analytic. For example, the smart outdoor system may generate an analytic describing a water level of a pool and may control an electronic refill valve based on the analytic (e.g., to prevent the swimming pool from overflowing, etc.). As another example, the smart outdoor system may generate an analytic describing an evaporation rate associated with a swimming pool and may electronically control a pool cover based on the analytic.

In some embodiments, the image data includes a number of frames of the swimming pool area, each of the number of frames having a different perspective. In some embodiments, determining the state associated with the characteristic of the swimming pool area includes warping, by the processing device, each frame to produce a number of transformed frames, each of the number of transformed frames having a top view, and/or combining, by the processing device, the number of transformed frames to produce a composite frame. In some embodiments, routine includes tracking a portion of a pixel of the composite frame using an image tracking algorithm. In some embodiments, the routine includes tracking a portion of a pixel of a frame of the number of frames of the swimming pool area. In some embodiments, the processing device executes the routine. In some embodiments, a second processing device executes the routine. In some embodiments, the processing device operates on 10 watts or less. In some embodiments, determining the state associated with the characteristic of the swimming pool area includes determining the state in response to either (i) an input from a neural network trained via historic image data or (ii) a time-based trigger.

In some embodiments, determining the processing queue includes sorting, by the processing device, a number of routines based on a processing overhead associated with each of the number of routines, and/or assigning, by the processing device, each of the number of routines to a device for execution based on the associated processing overhead. In some embodiments, determining the processing queue includes assigning routines associated with monitoring safety at the swimming pool area to the processing device. In some embodiments, determining the state associated with the characteristic of the swimming pool area includes determining whether the area includes a swimmer. In some embodiments, determining whether the swimming pool area includes the swimmer includes determining whether an activity of the swimmer is a concerning event or a non-concerning event.

In some embodiments, determining the state includes identifying, by the processing device, a node of a Markov model, and wherein the state corresponds to the node. In some embodiments, the node of the Markov model includes a predetermined processing queue. In some embodiments, constructing the processing queue includes constructing the processing queue from the predetermined processing queue. In some embodiments, the node corresponds to a state of construction in the swimming pool area. In some embodiments, the method includes updating the processing queue in response to receiving an input.

In some embodiments, the input includes an instruction for adding a second routine to the processing queue. In some embodiments, updating the processing queue includes updating an order of the processing queue in response to receiving the instruction for adding the second routine. In some embodiments, the processing queue includes a second routine and wherein an order of the routine and the second routine is determined based on the state associated with the characteristic of the swimming pool area.

Another implementation of the present disclosure is a system including a video camera, a processor, memory, and a program stored in the memory. The program may be configured to be executed by the processor. The program may include instructions to cause the processor to receive image data corresponding to an area, determine, based on the image data, a state associated with a characteristic of the area, determine a processing queue including a routine based on the state, and cause a device to execute the routine.

In some embodiments, the device executes the route to generate an analytic describing an operational characteristic of the swimming pool area. In some embodiments, the analytic is based on the state of the swimming pool area.

Another implementation of the present disclosure is a non-transitory computer-readable storage medium having instructions stored thereon that, when executed by a processor, causes the processor to receive image data corresponding to an area, determine, based on the image data, a state associated with a characteristic of the area, determine a processing queue including a routine based on the state, and cause a device to execute the routine.

In some embodiments, the device executes the routine to generate an analytic describing an operational characteristic of the swimming pool area. In some embodiments, the analytic is based on the state of the swimming pool area.

Another implementation of the present disclosure is a method for generating a representation of a swimming pool area. In some embodiments, the method includes receiving, by a processing device from a device monitoring the swimming pool area, data associated with a context of the swimming pool area, and/or receiving, by the processing device, an output from a routine. In some embodiments, the output identifies a feature from the data. In some embodiments, the feature is associated with a characteristic of an entity in the swimming pool area. In some embodiments, the method includes analyzing, by the processing device, the feature by at least one of (i) tracking the feature, (ii) correlating the feature with another feature, or (iii) correlating the feature with a previously classified entity to generate a classification describing the characteristic of the entity, and/or generating, by the processing device, a representation of the swimming pool area. In some embodiments, the representation of the swimming pool area includes the classification of the entity describing the characteristic of the entity based on analyzing the feature.

In some embodiments, analyzing the feature includes identifying a node of a Markov model associated with the entity and generating the classification based on the node. In some embodiments, the data associated with the context of the swimming pool area includes an image of the swimming pool area. In some embodiments, identifying the feature includes determining, by the processing device, for each pixel of the image, (i) a class describing a type of entity the pixel corresponds to and (ii) an instance of the type of entity the pixel corresponds to. In some embodiments, identifying the feature includes selecting a pixel from the image as the feature. In some embodiments, identifying the feature includes determining an identity of a person in the image.

In some embodiments, the classification includes at least one of (i) a cleanliness state, (ii) a drowning state, (iii) a swimming state, (iv) a usage state, (v) a coverage state, (vi) a construction progress state, or (vii) a service state. In some embodiments, the entity is a swimmer. In some embodiments, the feature is a pose of the swimmer. In some embodiments, the entity is a robotic skimmer. In some embodiments, the classification includes a pose of the robotic skimmer. In some embodiments, the method includes transmitting, to the robotic skimmer, the pose. In some embodiments, generating the representation of the swimming pool area includes identifying a 3-dimensional position of the robotic skimmer. In some embodiments, the method includes analyzing, by the processing device, the representation of the swimming pool area to generate an analytic describing an operational characteristic of the swimming pool area.

In some embodiments, generating the analytic includes tracking a number of people that enter a swimming pool. In some embodiments, the method includes receiving, by the processing device, an instruction, based on the classification of the entity, to cause a device to perform an action associated with the characteristic of the entity. In some embodiments, the entity includes pool debris. In some embodiments, transmitting the instruction includes transmitting a location of the pool debris to a robotic skimmer. In some embodiments, analyzing the feature includes tracking a water level of a pool over time.

Another implementation of the present disclosure is a method of controlling a swimming pool area. In some embodiments, the method includes receiving, by a processing device from a first device, first sensor data associated with a first physical characteristic of the swimming pool area, receiving, by the processing device from a second device, second sensor data associated with a second physical characteristic of the swimming pool area, analyzing, by the processing device, the first sensor data and the second sensor data to determine a correlation, identifying, by the processing device, an action based on the correlation, and/or transmitting, by the processing device, an instruction to cause the action to be performed, wherein the action is associated with a characteristic of the swimming pool area.

In some embodiments, the first device includes at least one of (i) a temperature sensor, (ii) a pH sensor, (iii) a camera, (iv) a robotic skimmer, (v) a pool pump, or (vi) a pool heater.

Another implementation of the present disclosure is a method of generating an image for image tracking. In some embodiments, the method includes receiving, by a processing device, image data corresponding to an area including a swimming pool, identifying, by the processing device, features from the image data corresponding to edges of the swimming pool via an edge detection algorithm, determining, by the processing device, a ground plane estimate based on the features, determining, by the processing device, a homographic mapping from a first point in an image of the image data to a second point in the ground plane estimate, and/or generating, by the processing device, based on the homographic mapping, a top perspective of the area.

In some embodiments, the image data includes two images having partially overlapping views of the area. In some embodiments, the method includes determining, by the processing device, a correlation between a first feature in a first image of the two images and a second feature in a second image of the two images, and/or combining, by the processing device, the first image and the second image to form a composite image based on the correlation. In some embodiments, determining the correlation includes generating, by the processing device, a fundamental matrix describing a relationship between the first image and the second image. In some embodiments, the method includes tracking a pixel of the composite image using an image tracking algorithm. In some embodiments, the first image is an aerial image.

In some embodiments, the first feature and the second feature each include a line. In some embodiments, the method includes identifying, by the processing device, a number of pixels in the image corresponding to a perimeter of the swimming pool based on the features. In some embodiments, the method includes transmitting, by the processing device to a device associated with a user, a recommendation of a perimeter of the swimming pool.

In some embodiments, the image data includes two images depicting a scene including an entity. In some embodiments, the method includes correlating a feature of a first image of the two images with a second feature of a second image of the two images to determine a pose of the entity. In some embodiments, the features include two lines corresponding to edges of the swimming pool.

### BRIEF DESCRIPTION OF THE DRAWINGS

FIG. 1 illustrates an exemplary smart outdoor system, in accordance with an embodiment.

FIG. 2 illustrates a block diagram of the smart outdoor system, in accordance with an embodiment.

FIG. 3 illustrates an exemplary method for monitoring a space, in accordance with an embodiment.

FIG. 4 illustrates an exemplary method for generating a representation of a space, in accordance with an embodiment.

FIG. 5 illustrates an exemplary method for controlling a space, in accordance with an embodiment.

FIG. 6 illustrate an exemplary method for generating an image for image tracking, in accordance with an embodiment.

FIG. 7 illustrates an exemplary orthomosaic image generated by the smart outdoor system, in accordance with an embodiment.

FIG. 8 illustrates an exemplary composite image generated by the smart outdoor system, in accordance with an embodiment.

FIG. 9 illustrates a computing device, in accordance with an embodiment.

### DETAILED DESCRIPTION

In the following description of embodiments, reference is made to the accompanying drawings which form a part hereof, and in which it is shown by way of illustration specific embodiments which can be practiced. It is to be understood that other embodiments can be used and structural changes can be made without departing from the scope of the disclosed embodiments.

Referring generally to the FIGURES, described herein are systems and methods of a smart outdoor system. The smart outdoor system may monitor a space, such as a backyard space. For example, the smart outdoor system monitors a backyard space using a number of cameras. Monitoring the space may include determining a state associated with the space.

For example, the smart outdoor system determines whether a backyard space is occupied. In various embodiments, the smart outdoor system determines a state associated with an entity/element within the space. For example, the smart outdoor system determines a cleanliness state of a swimming pool within the space (e.g., whether debris is present within the swimming pool, etc.). As another example, the smart outdoor system determines whether a swimmer within a swimming pool is exhibiting signs of distress. The smart outdoor system may leverage first state information to infer second state information. For example, the smart outdoor system classifies an object as a swimmer based on determining the object is a person, the object is located within a swimming pool, and a pose of the person corresponds to a swimming pose. In some embodiments, the smart outdoor system aggregates low-level state information to determine higher-level state information. For example, the smart outdoor system combines (i) a change in water color, (ii) a presence of a person nearby a pool, and (iii) a change in an amount of debris present in the pool to determine that the person is a pool cleaner who is cleaning the pool.

In various embodiments, the smart outdoor system performs actions. The actions may be dynamically determined based on a state of the space (or entities/elements therein).

For example, the smart outdoor system identifies debris within a pool and causes a robotic pool skimmer to remove the debris. In various embodiments, the smart outdoor system dynamically determines a processing queue based on a state of the space and/or entities/elements therein. For example, the smart outdoor system performs a first set of routines while a pool cover is covering a pool and performs a second set of routines while the pool cover is not covering the pool. In various embodiments, the smart outdoor system assigns routines to specific processing devices. For example, the smart outdoor system assigns a first set of routines to an edge processing device (e.g., a camera disposed at a location being monitored, etc.) and assigns a second set of routines to a remote processing device (e.g., the cloud, etc.) based on an amount of processing power associated with the routines.

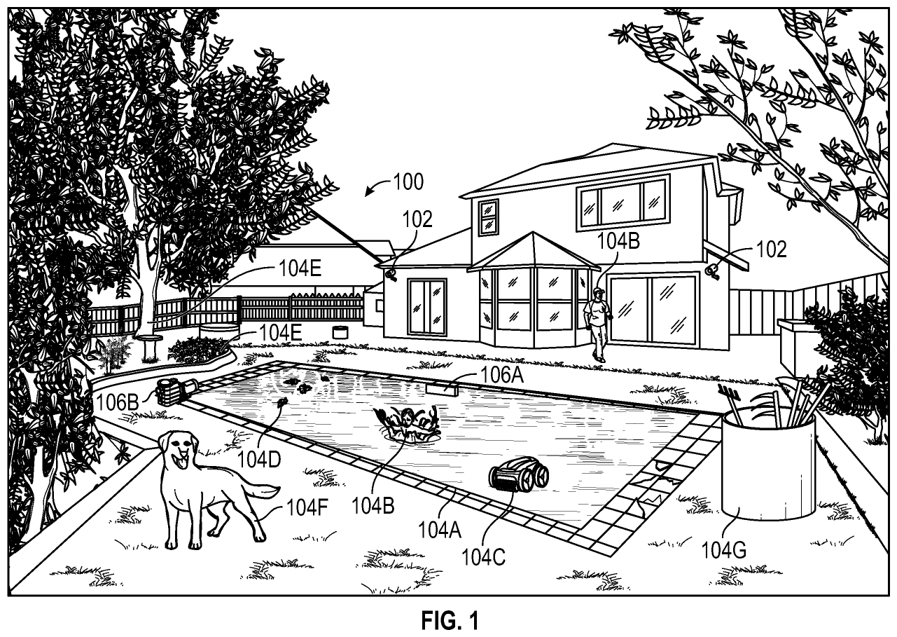

Turning now to FIG. 1, a smart outdoor system is shown, according to an exemplary embodiment. In some embodiments, the smart outdoor system generates a representation of space 100 and perform various routines/actions based on a state of space 100 and/or entities/elements therein. For example, the smart outdoor system tracks a cleanliness of a swimming pool in space 100 and causes a robotic pool skimmer to clean the swimming pool if it gets dirty. Generating the representation of space 100 may include generating a semantic model of space 100. For example, the smart outdoor system generates a digital twin of space 100 including a representation of people, objects, structures, and/or environmental conditions in space 100. Performing the various routines/actions based on a state of space 100 may include generating a processing queue having one or more routines, assigning the one or more routines to one or more processing devices, and/or causing one or more devices to perform one or more actions. For example, in response to determining that a pool is uncovered, the smart outdoor system generates a processing queue including a number of routines associated with monitoring safety at the pool, assigns a first set of the number of routines to an edge device (e.g., a camera, a GPU enabled microcontroller, a system-on-module (SOM) such as a NVIDIA® Jetson Nano™, an Intel® Neural Compute Stick 2, or an Ambarella® H22S85N™, etc.), assigns a second set of the number of routines to a remote device (e.g., a cloud computing device, etc.), and causes a robotic pool skimmer to return to a docking station (e.g., to prepare for a user to use the pool, to charge the robotic pool skimmer, etc.). As used herein, an “edge device” may refer to a processing device that operates on 10 watts or less. In some embodiments, an edge device refers to a device capable of 0.5*1012 or fewer floating-point-operations per second (e.g., 0.5 TFLOPs). In some embodiments, an edge device refers to a device having a processor with 80 kibibytes (KiB) or less of L1 cache and 2 mebibytes (MiB) or less of L2 cache per core.

The smart outdoor system described herein may offer benefits over existing systems. Traditional home automation systems may capture data at a location and transmit the data to a remote processing system (e.g., the cloud, etc.) for analysis. For example, a traditional home automation system may capture image data at a location and transmit the image data to the cloud for object detection (e.g., to detect intruders, etc.). However, continuously transmitting data to the cloud may require a large amount of network bandwidth. Moreover, cloud computing may be expensive (e.g., compared to local computing). For example, processing a routine on a device may require a device having sufficient processing power, which may be more costly. If the device does not have sufficient processing power, the task may be performed slowly, which may be undesirable in some context (e.g., safety monitoring, etc.). The smart outdoor system may solve these problems by dynamically splitting processing between one or more edge devices and the cloud. For example, the smart outdoor system performs object detection using an edge processing device and transmits data to the cloud once the edge processing device has detected an object, thereby reducing bandwidth requirements associated with continuously transmitting data to the cloud and saving on cloud computing costs associated with continuously performing object detection in the cloud. It may be desirable to split processing associated with monitoring a space between a number of devices. For example, it may be desirable to perform safety-related processing using a device disposed at a location rather than using a remotely located device (e.g., the cloud, etc.) to provide robustness against network interruptions. As another example, it may be desirable to perform a first number of routines using an edge device (e.g., to save on cloud computing costs, etc.) and a second number of routines using a cloud processing system (e.g., for routines that require more processing power than is available with an edge device, etc.).

In addition, the smart outdoor system may perform safety critical processing using an edge device (e.g., a camera, etc.), thereby ensuring that critical functionality is not lost if a network connection is interrupted, unlike in traditional home automation systems that may rely entirely on cloud processing. For example, the smart outdoor system monitors pool safety using an edge device, thereby ensuring that a user will be alerted to a concerning event (e.g., a drowning swimmer, etc.) even if the edge device becomes disconnected from a network. Safety critical processing may include processing associated with user safety. For example, safety critical processing includes monitoring a pool to identify unsafe behavior (e.g., distressed-swimming, drowning, prolonged periods underwater, slip-and-fall injuries, etc.).

The smart outdoor system described herein may facilitate generating analytics associated with a space and/or an entity/element within a space. For example, the smart outdoor system tracks a number of people that use a swimming pool and generates a bather count for the swimming pool. In addition, the smart outdoor system may perform dynamic actions based on monitoring a space. For example, the smart outdoor system identifies debris within a pool and, in response, causes a robotic pool skimmer to capture the debris. Traditional home automation systems may not support this functionality.

Referring still to FIG. 1, space 100 may include an outdoor space such as a backyard. Additionally or alternatively, space 100 may include other outdoor spaces such as a driveway, a patio, a rooftop deck, a walkway, a gazeebo, a space along a side of a house, and/or the like. In various embodiments, a backyard space includes any such outdoor spaces (e.g., a driveway, a patio, a rooftop deck, a walkway, a gazeebo, a space along a side of a house, etc.). Moreover, it should be understood that while the smart outdoor system is described in relation to a backyard space, the smart outdoor system can monitor any space. For example, the smart outdoor system may monitor an indoor swimming pool space or an indoor activity space. Space 100 may include a number of entities 104A-104G. Entities 104A-104G may include swimming pool 104A, people 104B, robotic pool skimmer 104C, debris 104D, plants 104E, pets 104F, and/or equipment 104G. It should be understood, however, that entities 104A-104G are not limited to these examples and may include anything found in an outdoor space.

The smart outdoor system may monitor entities 104A-104G via camera 102. In some embodiments, the smart outdoor system uses more than one camera. It may be useful to use more than one camera in situations where a single camera view cannot capture a scene of interest (e.g., because the scene of interest is occluded by a first camera view or because the scene of interest is outside a frame of the first camera view, etc.). For example, the smart outdoor system combines image data from a number of cameras to form an orthographic image for image tracking. Moreover, it may be useful to use more than one camera to perform depth estimation. For example, the smart outdoor system combines image data from a number of cameras to determine a 6-dimensional pose (e.g., of a device, of an individual). It may be useful to use more than one camera to determine occlusions in a scene. For example, the smart outdoor system determines, based on comparing a number of different camera views, that a tree in a first camera view is partially occluding a view of a swimming pool. Monitoring entities 104A-104G may include determining a state associated with a characteristic of space 100 and/or entities 104A-104G. For example, the smart outdoor system determines a cleanliness state of swimming pool 104A (e.g., whether swimming pool 104A requires cleaning or not, etc.). The smart outdoor system may determine the state associated with space 100 and/or entities 104A-104G by analyzing data using a machine learning (ML) model (e.g., an artificial neural network, a support vector machine, a regression model, a Bayesian network, etc.) trained using historical data. For example, the smart outdoor system analyzes image data using a ML model trained using historical image data to classify an object as a dog. As another example, the smart outdoor system correlates temperature data and the output from a routine configured to determine a water level within a pool to determine a rate of evaporation from the pool. In various embodiments, the smart outdoor system updates the ML model using an output from processing. For example, the smart outdoor system may classify an object using statistical analysis (e.g., determine a correlation indicative of a classification) and may update a ML model with the classification.

In various embodiments, the smart outdoor system aggregates characteristics of space 100 and/or entities 104A-104G to determine new state information. For example, the smart outdoor system infers the identity of an individual as a pool cleaner based on tracking movements of the individual and correlating the movements with a change in an amount of debris within a swimming pool.

In various embodiments, the smart outdoor system generates a digital representation of space 100. For example, the smart outdoor system generates a digital twin of a backyard space that includes a digital representation of the entities/elements within the backyard space. The smart outdoor system may integrate state information into the digital representation. For example, the smart outdoor system determines that plants 104E require watering (e.g., based on image analysis, etc.) and updates a digital representation of plants 104E to reflect this. As another example, the smart outdoor system updates a digital representation of a pool to track a number of users that have entered the pool.

In some embodiments, the smart outdoor system represents space 100 using a Markov model. For example, the smart outdoor system represents various phases of a pool construction project using nodes of a Markov model (e.g., with each node corresponding to a phase of construction, etc.). As another example, the smart outdoor system identifies a repair project (e.g., a cracked tile requiring repair as shown in FIG. 1) and represents phases of the repair project using nodes of a Markov model as discussed in greater detail below.

In some embodiments, the smart outdoor system identifies occlusions within a camera view. For example, the smart outdoor system tracks an individual within a camera view and determines when the individual walks behind a fence, thereby becoming occluded from the camera view. In various embodiments, the smart outdoor system integrates an understanding of occlusions into the digital representation of the space. For example, the smart outdoor system generates a visibility graph and/or segments an image into layers corresponding to depth (e.g., such that a first layer represents objects in a first depth plane and a second layer represents objects in a second depth plane that is behind the first depth plane relative to the camera, etc.). As another example, the smart outdoor system updates a semantic representation of an object (e.g., a wall, a tree, etc.) to indicate that the object is occluding an entity such as a person. In some embodiments, the smart outdoor system identifies occlusions based on user input. For example, a user may draw a boundary around a wall on a user interface and the smart outdoor system may update a digital representation of a space to reflect that the area enclosed by the boundary may occlude a portion of the space. Additionally or alternatively, the smart outdoor system may dynamically identify occlusions based on tracking objects within the space. For example, the smart outdoor system may track an individual in a camera view and determine that the individual disappears from tracking along a boundary within a frame of the camera view and may update a digital representation of a space to reflect that the boundary corresponds to an occlusion.

In various embodiments, monitoring space 100 includes performing theft protection. For example, in response to identifying equipment 104G, the smart outdoor system adds a routine to a processing queue to cause a device to analyze image data of space 100 to detect whether an individual removes equipment 104G (e.g., by correlating an object classified as an individual with a movement of equipment 104G out of a designated area, etc.). In various embodiments, the smart outdoor system differentiates between individuals authorized to interact with equipment 104G and those not authorized to interact with equipment 104G (e.g., based on facial recognition, etc.). For example, the smart outdoor system generates an alert if an unauthorized individual attempts to remove equipment 104G.

In various embodiments, the smart outdoor system monitors space 100 and reduces a need for human intervention. For example, the smart outdoor system identifies a person in swimming pool 104A using image recognition and determines an occurrence of an event (e.g., drowning, distressed swimming, etc.) based on analyzing a pose of the person. The smart outdoor system may receive inputs from additional sources 106A-106B. For example, the smart outdoor system receives pH data from pH sensor 106A and receives power consumption information from pool pump 106B. In various embodiments, the smart outdoor system aggregates information from additional sources 106A-106B and/or camera 102 to determine a state of space 100 and/or entities 104A-104G. For example, the smart outdoor system correlates a color of a pool determined using image recognition with a pH measurement from pH sensor 106A to determine a cleanliness state of swimming pool 104A.

Smart outdoor system may dynamically perform routines/actions based on state information. For example, the smart outdoor system automatically causes robotic pool skimmer 104C to clean swimming pool 104A in response to identifying debris 104D within swimming pool 104A (e.g., identifying a dirty pool state, etc.). As another example, the smart outdoor system determines that a pool is under construction and performs a first set of routines to monitor construction progress of the pool and ensure that equipment used in constructing the pool is not stolen (e.g., by alerting a user if an individual is detected removing the equipment, etc.). To continue the previous example, once the pool is fully constructed, the smart outdoor system performs a second set of routines to monitor safety of individuals using the pool (e.g., by alerting a user if an individual is performing a concerning activity such as drowning, etc.). In various embodiments, the smart outdoor system dynamically generates a processing queue based on the semantic model and/or the determined state. For example, in response to determining a pool cover is open, the smart outdoor system causes a camera to perform object detection within an area defined as a swimming pool and causes a cloud computing device to classify any objects detected by the camera within the area. Generating the processing queue may include assigning one or more routines of the processing queue to one or more processing devices. For example, the smart outdoor system assigns a first set of routines requiring a small amount of processing power (e.g., capable of 5*10⁹ FLOPs) to an edge device (e.g., camera 102, etc.) and assigns a second set of routines requiring a larger amount of processing power to a remote processing device (e.g., a cloud computing device, etc.). Advantageously, dynamically assigning routines between processing devices may reduce cloud computing costs, improve a robustness of the smart outdoor system (e.g., such that an edge device can continue to operate if a connection to a cloud computing device is lost, etc.) and/or reduce bandwidth overhead (e.g., associated with transmitting data such as image data to a cloud computing device, etc.).

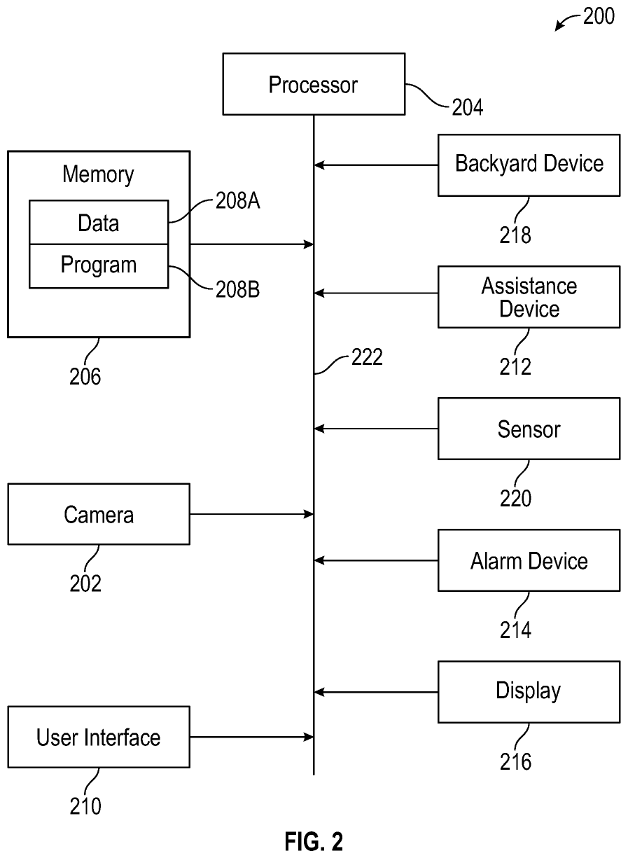

Referring now to FIG. 2, smart outdoor system 200 is shown, according to an exemplary embodiment. Smart outdoor system 200 may be used in the facilities disclosed herein. For example, smart outdoor system 200 may monitor a space such as a backyard space. As another example, smart outdoor system 200 may monitor an indoor pool. In various embodiments, smart outdoor system 200 is used in an outdoor space (e.g., a backyard space, etc.). Additionally or alternatively, smart outdoor system 200 may be used in an indoor space (e.g., an indoor swimming pool, an indoor activity space, etc.). In various embodiments, smart outdoor system monitors a space to determine a state associated with the space (and/or entities/elements included therein) and to determine a processing queue based on the state. For example, smart outdoor system 200 identifies an individual as a swimmer and generates a processing queue having a number of routines associated with determining whether the swimmer is engaged in concerning behavior (e.g., distressed swimming, drowning, etc.). As another example, smart outdoor system 200 models construction progress for a swimming pool using a Markov model and identifies a node of the Markov model corresponding to a current phase of construction based on analyzing image data of the construction site. The routines may include specific artificial intelligence (AI) and/or machine learning (ML) based routines associated with detecting specific events/conditions within the space. For example, the processing queue includes a first routine to determine whether a swimmer is engaged in concerning behavior, a second routine to determine whether a swimming pool needs to be cleaned, a third routine to generate usage analytics for the swimming pool, and a fourth routine to monitor a water level of the swimming pool.

In some embodiments, smart outdoor system 200 includes camera 202, processor 204, memory 206, user interface 210, assistance device 212, alarm device 214, display 216, backyard device 218, and/or sensor 220. Elements of the smart outdoor system 200 may be connected with communication link 222. In some embodiments, communication link 222 is wireless. For example, communication link 222 may represent a wireless network, and the wireless network may include a wireless router. As another example, communication link 222 may be a WiFi, Bluetooth, or mobile network (e.g., 4G, LTE, 5G). As yet another example, communication link 222 may be or include a wired link.

Elements of smart outdoor system 200 may be included in subsystems. For example, processor 204 and memory 206 may be included in a processing device (e.g., a computer, a server, a cloud computing device), separate from the other elements, where data (e.g., video frames) from camera 202 is processed and analyzed and a detection signal to activate the alarm device may be transmitted, depending on the analysis. The processing device may be a single processing device and/or multiple processing devices (e.g., in a distributed processing system, etc.). For example, any routine/processing queue performed by a processing device may be performed by a single processing device and/or multiple processing devices (e.g., in a distributed processing system). In some embodiments, the computing device transmits a video stream in response to receiving a query from an application of another device. In some embodiments, the computing system and the camera are configured to communicate wirelessly. In some embodiments, the computing device is one of AI processor, cloud computing platform, a processor with AI and video/graphics booster technology having sufficient computation power and processing speed, a fast computing platform, and a parallel computing platform. For example, the computing device includes a central processing unit (CPU), a hardware accelerated graphics processing unit (GPU), an image/video accelerated processor (e.g., an image signal processor, a digital signal processor, etc.), and/or the like. In some embodiments, smart outdoor system 200 includes a first computing device (e.g., a base station, a computer) in the same local network as camera 202 for initially processing information (e.g., video frames from camera 202, etc.) and a second computing device not in the local network (e.g., a server, a cloud computing device) for subsequently processing the information (e.g., video frames, etc.) and transmitting an output (e.g., a video stream, etc.) in response to receiving a query from an application of a third device. By performing the processing and analysis in a computing device instead of the camera, the complexity and cost of the camera (and hence the cost of the system) may be advantageously reduced.

As another example, processor 204 and memory 206 may be included in camera 202. That is, the processing and analysis of data (e.g., video frames) received from camera 202 may be performed by the camera itself without a separate computing device. Depending on the analysis, camera 202 may transmit a detection signal to user interface 210, assistance device 212, and/or alarm device 214 (e.g., a swimmer is determined to be drowning, and the camera transmits the signal to activate user interface 210, assistance device 212, and/or alarm device 214). As yet another example, smart outdoor system 200 may not include a camera, and the camera is separate from elements (e.g., elements of a computing system) configured to process images captured by the camera (e.g., the cameras are provided by the pool facilities, a separate off-the-shelf camera is used). Camera 202 may be static (e.g., fixed in a single location, a pan-tilt-zoom security camera, etc.) or dynamic (e.g., integrated with a robotic pool skimmer, integrated into a drone, etc.).

Smart outdoor system 200 may be used as illustrated in FIG. 1. For example, camera 202 may be camera 102 and sensor 220 may be at least one of pH sensor 106A, pool pump 106B, and/or robotic pool skimmer 104C. Alarm device 214 may provide a visual, audio, or haptic alert indicating an event (e.g., that a swimmer is drowning, etc.). For example, as described herein, based on whether a criterion is met (described in more detail below), the system generates a detection signal that causes alarm device 214 to present an alarm (e.g., to a lifeguard, to a safety personnel, to a guardian of the drowning swimmer, to a facilities manager, to a homeowner). Smart outdoor system 200 may advantageously determine an occurrence of an event (e.g., drowning) and generate an alert equal or quicker than the lifeguard's determination. For example, the system may detect a drowning swimmer quicker than the lifeguard because the lifeguard may be surveying portions of the pool at each time. As a result, the lifeguard may be able to act accordingly (e.g., help the drowning swimmer) quickly.

Assistance device 212 may be and/or include a life saving device (e.g., a rescue robot, the EMILY Hydronalix Rescue Robot) or a buoyancy device (e.g., a device that can lift a person experiencing a drowning event above the water). In some embodiments, assistance device 212 is activated or made available to a user of the system (e.g., a lifeguard, a safety personnel, a facilities manager, a homeowner, a guardian of the drowning swimmer) in response to generation of a detection signal (e.g., the system determines that someone is drowning, and the system activates or makes the assistance device available to rescue the actively drowning swimmer).

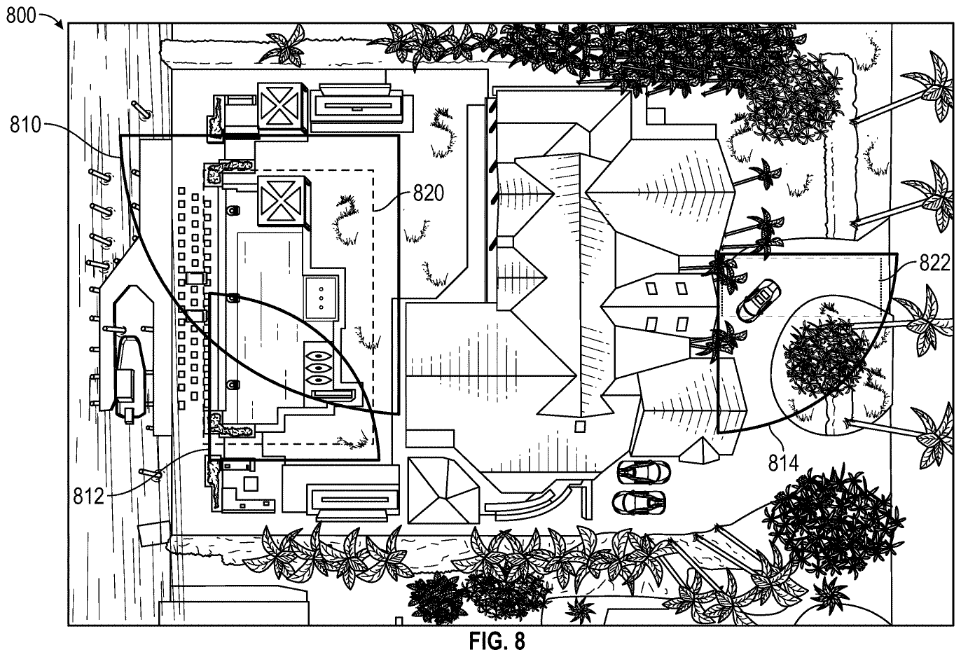

In some embodiments, display 216 may be a touch screen and configured to display user interface 210. In some embodiments, user interface 210 is separately presented from display 216. User interface 210 may be configured to receive an input from a user (e.g., a touch input, a button input, a voice input), and a setting of the system may be updated in response to receiving the input from the user. As an exemplary advantage, user interface 210 allows a user to efficiently monitor a space and contextualize objects present within different camera views. For example, a user views a composite image having a number of orthographic images overlaid onto an aerial view as described below with reference to FIG. 8. As another exemplary advantage, user interface 210 may allow a user to control entities/elements (e.g., backyard device 218, etc.) within a backyard space using voice commands (e.g., cause an automatic pool cover to open based on a voice command, etc.).

In some embodiments, display 216 is integrated with camera 202. In some embodiments, display 216 is included with a computer system that includes processor 204 and memory 206. In some embodiments, display 216 is a device separate from camera 202, processor 204, and memory 206.

Backyard device 218 may be and/or include any system/device located in a space such as a backyard. As a non-limiting example, backyard device 218 may include an automatic awning, a sprinkler system, a robotic lawn mower, a robotic pool skimmer, a lighting system, an automatic pool cover, a pool heater, a pool pump, a security system, and/or the like. In various embodiments, smart outdoor system 200 interacts with backyard device 218. For example, smart outdoor system 200 receives information from a robotic pool skimmer (e.g., position information, battery status, etc.) and transmits instructions to the robotic pool skimmer to cause the robotic pool skimmer to capture debris within a pool. In some embodiments, smart outdoor system 200 includes an application programming interface (API) to facilitate communication with external systems/devices such as one of backyard device 218.

In various embodiments, smart outdoor system 200 receives information from sensor 220. Sensor 220 may be and/or include any system/device configured to capture information. As a non-limiting example, sensor 220 may include a pH sensor, a temperature sensor, a humidity sensor, a light sensor, a moisture sensor, a proximity sensor, a motion detector, a wireless receiver (e.g., a Bluetooth® receiver, etc.), a limit switch, a weight sensor, an imaging device (e.g., camera 102, etc.), a microphone, and/or the like. Sensor 220 may be a standalone sensor and/or may be integrated within a device. For example, sensor 220 may include a camera integrated into a robotic pool skimmer. In various embodiments, sensor 220 transmits information to smart outdoor system 200 (e.g., via communication link 222, etc.). For example, smart outdoor system 200 receives information from sensor 220 via a wired and/or a wireless connection. In various embodiments, smart outdoor system 200 analyzes the sensor information to determine a state of a space such as a backyard space.

In some embodiments, memory 206 includes data 208A and program 208B. Data 208A and/or program 208B may store instructions to cause processor 204 to perform the methods disclosed herein. In some embodiments, data 208A is part of a storage system of a computer system or an online storage system, and the captured frames are stored in a storage system of the computer system or an online storage system. Smart outdoor system 200 may include one or more devices each having one or more of processor 204 and memory 206. For example, smart outdoor system 200 may include a first edge device (e.g., camera, etc.) having a first processor and first memory and a second remote device (e.g., cloud computing server, etc.) having a second processor with more processing power than the first processor and a second memory with a greater capacity than the first memory.

In various embodiments, smart outdoor system 200 generates a processing queue and assigns routines (e.g., machine-executable instructions, tasks, etc.) to different processing devices based on various criteria. For example, smart outdoor system 200 assigns routines requiring a small amount of processing power to an edge device and assigns routines requiring a large amount of processing power to a cloud computing device. As another example, smart outdoor system 200 assigns routines associated with monitoring a pool for safety (e.g., detecting a user in a pool, safety critical processing, etc.) to an edge device and assigns routines associated with generating pool analytics to a cloud computing device. As yet another example, smart outdoor system 200 assigns routines associated with object detection (e.g., identifying a person in a backyard space, etc.) to an edge device and assigns routines associated with tracking and/or classifying the detected object to a cloud computing device. The criteria may include a priority/importance of the routine, data bandwidth associated with the routine, expected computing time associated with the routine, a processing deadline associated with the routine (e.g., when the routine needs to be finished by, etc.), currently available processing resources, and/or the like. In some embodiments, smart outdoor system 200 determines the processing queue based on pre-defined rules. For example, smart outdoor system 200 may prioritize distress detection (e.g., detecting/identifying a distressed swimmer, etc.) and deprioritize cleaning detection (e.g., determining whether a pool needs to be cleaned, etc.) in response to detecting a person in a pool. Advantageously, splitting routines between an edge device and a cloud computing device may save on computing costs (e.g., costs associated with renting cloud computing processing capabilities, etc.) and/or may reduce/eliminate a loss of some functionality (e.g., safety monitoring, etc.) in the event of a network failure (e.g., if a cloud computing device were relied on to perform the functionality, etc.).

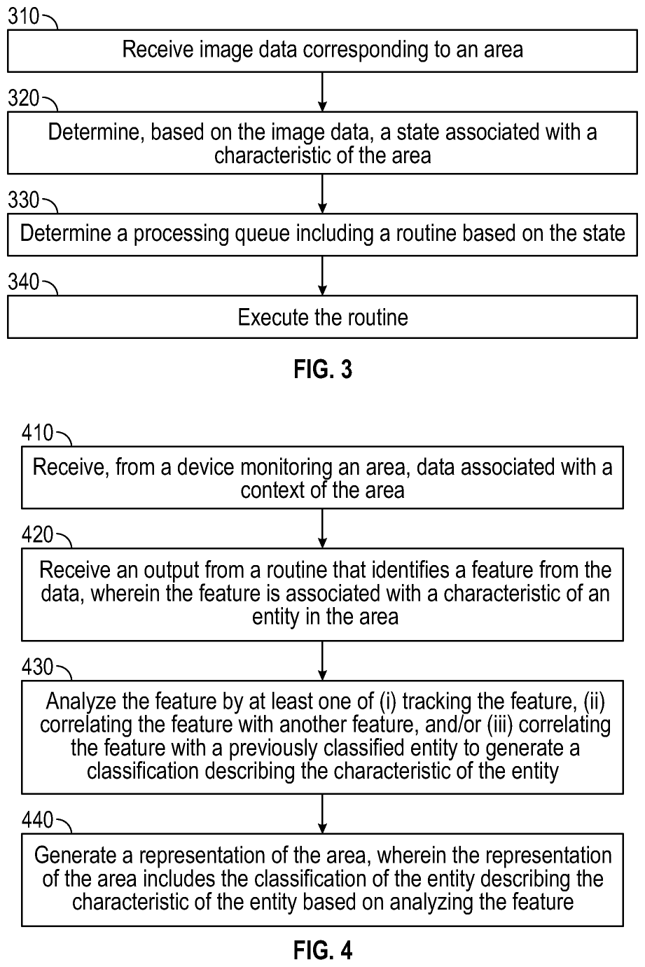

Referring now to FIG. 3, a method for monitoring a space is shown, according to an exemplary embodiment. Speaking generally, smart outdoor system 200 may dynamically schedule routines (e.g., tasks, etc.) for execution based on a state of a space. For example, smart outdoor system 200 uses image recognition to determine that a construction project in a backyard space has transitioned from a first phase (e.g., a pre-construction phase, etc.) to a second phase (e.g., a sitework and foundation phase, etc.) and, in response, generates a processing queue having a number of routines (e.g., to cause a processing device to monitor equipment at the jobsite, etc.). As another example, smart outdoor system 200 performs motion detection using a motion sensor and, in response to detecting motion, triggers an object tracking routine. As another example, smart outdoor system 200 executes a first routine (e.g., an object detection routine) and in response to a condition such as detecting the presence of a toddler/child, executes a second routine (e.g., a tracking routine to monitor a location of the toddler/child, etc.). As yet another example, smart outdoor system 200 executes a first routine to identify pool debris until a person is detected in a pool and, in response, terminates the first routine and initiates a second routine to track the person. In various embodiments, dynamically rescheduling routines is beneficial to efficiently allocate compute resources. For example, it may be beneficial to reallocate compute resources from other tasks to monitoring safety within a swimming pool once an individual enters the swimming pool. However, when an individual is not within the swimming pool, the compute resources may be used to perform other tasks such as generating analytics associated with a space or tracking a health of plants in a space, etc.

In various embodiments, smart outdoor system 200 performs the method. For example, a processing device (e.g., comprising processor 204 and memory 206, etc.) may perform the method. In various embodiments, one or more steps of the method are split between a number of processing devices. For example, a first processing device (e.g., a camera with onboard processor, etc.) may perform steps 310-330 and a second processing device (e.g., a cloud computing device, etc.) may perform step 340. As another example, a first processing device (e.g., a camera with an onboard processor, etc.) may perform steps 310-320 and a second processing device (e.g., a cloud computing device, etc.) may perform steps 330-340. It should be understood that any action(s) performed by a processing device as described herein may be performed by a single processing device and/or multiple processing devices (e.g., in a distributed processing system, etc.). In various embodiments, the processing device is a resource constrained device (e.g., a device having less than 100 KB of L1 cache, 5 MB of L2 cache, a clock speed of 1.5 GHz or less, etc.).

At step 310, smart outdoor system 200 may receive image data corresponding to an area. The area may include any outdoor space. For example, the area may include a backyard, a front yard, an area on a side of a house, a rooftop, a patio, and/or the like.

Additionally or alternatively, the area may include an indoor space such as an indoor pool or indoor activity space. In various embodiments, the image data includes one or more frames each having a perspective that at least partially includes a view of the area. In various embodiments, smart outdoor system 200 receives the image data from a camera (e.g., camera 202, etc.). The camera may be static (e.g., fixed in a single location, a pan-tilt-zoom security camera, etc.) or dynamic (e.g., integrated with a robotic pool skimmer, integrated into a drone, etc.). In some embodiments, smart outdoor system 200 receives image data from a number of cameras. For example, smart outdoor system 200 receives first image data having a first perspective from a first camera and receives second image data having a second perspective from a second camera.

In some embodiments, smart outdoor system 200 receives additional data. For example, smart outdoor system 200 receives data from sensors deployed in/around the area (e.g., pH sensor 106A, pool pump 106B, etc.). Additionally or alternatively, smart outdoor system 200 may receive data from other sources (e.g., weather feeds, etc.).

At step 320, smart outdoor system 200 may determine, based on the image data, a state associated with a characteristic of the area. For example, smart outdoor system 200 determines a cleanliness state of a swimming pool (e.g., swimming pool 104A, etc.). In various embodiments, step 320 includes performing image recognition. For example, smart outdoor system 200 performs image recognition on an image of the area to determine whether a person is present (e.g., an occupied state). In various embodiments, the state is associated with a physical characteristic of the area and/or an entity/element within the area. For example, smart outdoor system 200 performs image recognition on an image of plants 104E to determine a health of plants 104E (e.g., whether they require watering, etc.). As another example, in a swimming pool context, step 320 may include determining whether the area includes a swimmer (e.g., performing image segmentation to identify a person within swimming pool 104A, etc.). In various embodiments, determining the state includes determining an activity associated with an entity. For example, smart outdoor system 200 determines whether an activity of an entity identified as a swimmer is a concerning event (e.g., distressed swimming, drowning, etc.) or a non-concerning event (e.g., playing, lap swimming, etc.). Determining the state may include determining an entity type (e.g., swimmer, service personnel, child, toddler, gardener, pet, burglar, pool float, leaves, robotic pool skimmer, lawn mower, sprinkler, trees, bushes, flowers, etc.), identifying an action (e.g., lap swimming, playing, cleaning, running, lawn mowing, watering, trimming, building, diving, etc.), determining an environmental condition (e.g., rain, wind, sun, snow, etc.), determining an analytic (e.g., a lawn mower pattern, a robotic pool skimmer runtime/distance, calories burnt, time spent in pool, growth rate of plants, cost-per-swim, a demand factor, an evaporation factor, a greenhouse emission reduction amount, etc.), a status (e.g., open/closed pool cover, clean/dirty pool, in use/not in use, plant watering status, etc.), an event (e.g., a pool freeze, a tornado/hurricane/storm, intrusion detection, a fire alert, etc.), and/or the like. In some embodiments, step 320 includes processing data such as the image data (e.g., a subset of the image data, all of the image data, etc.) to extract information. For example, an instance running on a cloud computing device processes the image data to extract a semantic classification. In some embodiments, step 320 includes identifying occlusions within the area based on the image data. For example, smart outdoor system 200 tracks an individual and determines that the individual disappeared from view upon encountering an object labeled as a wall and determines that the wall occludes a portion of a view depicted by the image data.

In some embodiments, step 320 is performed in response to a trigger. The trigger may include an event trigger and/or a time trigger. For example, smart outdoor system 200 may perform step 320 in response to detecting movement within the one or more frames. As another example, smart outdoor system 200 may perform step 320 every 3 hours. In some embodiments, the trigger includes receiving an output of a ML model (e.g., a neural network, etc.) trained using historic image data. For example, smart outdoor system 200 may perform step 320 in response to receiving an output from an ANN indicating that a pool is at risk of freezing (e.g., based on external weather data, etc.). Additionally or alternatively, the trigger may include an output from an external source (e.g., sensor, data feed, etc.). For example, a fire suppression system may trigger smart outdoor system 200 to deploy sprinklers in a backyard space.

In some embodiments, determining the state includes identifying a node of a Markov model. For example, smart outdoor system 200 represents the area (and/or entities/elements thereof) using a Markov model and identifies a node of the Markov model corresponding to the state of the area (and/or entities/elements thereof). The Markov model may be implemented as a graph data structure. For example, smart outdoor system 200 represents a “clean pool” state using a first node, represents a “dirty pool” state using a second node, and represents a connection between the first and second nodes using an edge that corresponds to whether debris is detected within the pool. Nodes of the Markov model may include a predetermined processing queue. For example, a node corresponding to a “dirty pool” state may include a predetermined processing queue that includes a routine to cause a robotic pool skimmer to clean the pool. In various embodiments, step 320 includes constructing the processing queue from the predetermined processing queue. For example, smart outdoor system 200 retrieves a predetermined processing queue corresponding to a node associated with a state of the area and causes routines of the predetermined processing queue to be executed (e.g., by assigning the routines to one or more processing devices, etc.).

In some embodiments, smart outdoor system 200 models a state of construction progress. For example, smart outdoor system 200 models the construction of a swimming pool using a Markov model (e.g., where different nodes of the Markov model correspond to different phases of construction, etc.). Additionally or alternatively, smart outdoor system 200 may generate construction analytics. For example, smart outdoor system 200 tracks a number of labor-hours required to pour concrete for a new pool and reports the number of labor-hours to a user. As another example, smart outdoor system 200 receives a cost of maintenance and determines a cost per swim (e.g., based on tracking a number of times a user used a pool, etc.). As yet another example, smart outdoor system 200 correlates usage data with a time of year to determine a demand factor (e.g., average number of times a pool is used by at least a single person every week, etc.). As yet another example, smart outdoor system 200 tracks an amount of time a pool pump runs to generate a greenhouse emission reduction analytic.

In some embodiments, smart outdoor system 200 tracks construction progress/a construction area using image processing. For example, smart outdoor system 200 applies image processing to determine whether a project is on-schedule (e.g., by comparing features of the construction area to features associated with a particular phase of construction, etc.).

As another example, smart outdoor system 200 determines whether a feature of the construction conforms to a standard (e.g., is in compliance with a safety standard, etc.). As yet another example, smart outdoor system 200 monitors construction worker safety (e.g., by determining whether the workers are using safety equipment, whether the workers are following safety protocols, etc.). In some embodiments, smart outdoor system 200 facilitates remote monitoring of construction progress/a construction area. For example, an engineer or manager may monitor construction progress remotely using a personal device and smart outdoor system 200 may generate a dashboard including safety statistics (e.g., how many unsafe events have occurred over a time period, etc.) and a phase of the construction progress.

In some embodiments, step 320 includes combining the one or more frames to produce a composite frame (e.g., an orthographic image, etc.). For example, smart outdoor system 200 warps each of the one or more frames to produce a number of transformed frames each having a top view and combines the number of transformed frames into a composite frame as described in detail with reference to FIG. 6 below. In various embodiments, warping each of the one or more frames includes digitally manipulating the one or more frames (e.g., performing forward mapping, etc.). For example, warping an image includes mapping a pixel having a first location in a first image (e.g., a source image) to a second location in a second image (e.g., the warped image). In some embodiments, warping includes resampling and/or interpolation. In some embodiments, smart outdoor system 200 may perform image tracking using the composite frame. For example, smart outdoor system 200 tracks a pixel of the composite frame using an image tracking algorithm. Additionally or alternatively, smart outdoor system 200 may perform image tracking using the one or more frames (e.g., before being combined).

At step 330, smart outdoor system 200 may determine a processing queue including a routine based on the state. For example, smart outdoor system 200 assigns a first series of routines to a first processing device and a second series of routines to a second processing device. Smart outdoor system 200 may determine the processing queue order/composition based on various parameters. For example, smart outdoor system 200 splits routines between a first processing device and a second processing device based on (i) an amount of computing power required for the routine, (ii) a state of the area, (iii) user preferences, (iv) parameters associated with the routine, and/or the like.

In various embodiments, smart outdoor system 200 updates the processing queue in response to receiving an input. For example, smart outdoor system 200 updates a processing queue having a first routine by adding a second routine to the processing queue.

As another example, smart outdoor system 200 reorders one or more routines within the processing queue based on the input. In some embodiments, the input includes an instruction (e.g., to add another routine to the processing queue, etc.). Additionally or alternatively, the input may include a trigger as described above with reference to step 320. For example, smart outdoor system 200 updates the processing queue in response to receiving a weather safety alert from a weather data feed. As another example, smart outdoor system 200 updates the processing queue in response to determining a user has entered a pool (e.g., to prioritize routines associated with monitoring a safety of the user over other routines such as those associated with monitoring a health of plants in the space, etc.).

In various embodiments, smart outdoor system 200 generates the processing queue based on a processing overhead associated with each of the number of routines. For example, smart outdoor system 200 sorts a number of routines based on a processing overhead associated with each of the number of routines and assigns each of the number of routines to a device for execution based on the associated processing overhead (e.g., assign low processing-overhead routines to an edge device and assign high processing-overhead routines to a cloud-based processing device, etc.). In some embodiments, smart outdoor system 200 assigns specific routines to an edge device. For example, smart outdoor system 200 assigns routines associated with monitoring safety at a swimming pool (e.g., swimming pool 104A, etc.) to an edge device. Assigning specific routines to an edge device may enable smart outdoor system 200 to continue providing a functionality associated with the routines if a network connection is interrupted/lost. For example, smart outdoor system 200 may continue to monitor a swimming pool for distressed swimmers even if a network connection is lost.

At step 340, smart outdoor system 200 may execute the routine. For example, a processing device (e.g., comprising processor 204 and memory 206, etc.) may transmit a routine to a motor controller (e.g., backyard device 218, etc.) to cause an awning to be unfurled. As another example, a processing device may transmit a routine to a pool pump to cause the pool pump to operate (e.g., in response to determining that a cleanliness of the pool water has fallen below a threshold, etc.). In some embodiments, step 340 includes transmitting a notification to a user (e.g., a visual alert via a light, an audio alert via a speaker, a digital notification via a mobile device, etc.). In various embodiments, the routine includes machine-readable instructions. For example, the routine may include machine-readable instructions to cause a robotic pool skimmer to capture debris in a specific location. In some embodiments, step 340 is performed by a single device (e.g., a robotic pool skimmer, etc.).

Additionally or alternatively, more than one device may execute the routine. For example, an edge device and a cloud computing device may execute the routine collaboratively (e.g., by performing different processing in parallel, etc.). As another example, an edge device and a cloud computing device may execute different portions of the routine separately (e.g., in series, etc.).

Referring now to FIG. 4, a method for generating a representation of a space is shown, according to an exemplary embodiment. Speaking generally, smart outdoor system 200 may generate a digital representation of a space, such as a backyard space including a swimming pool. The digital representation may represent a state of the space and/or entities/elements within the space. For example, smart outdoor system 200 represents a swimming pool that is under construction using a state describing a phase of the construction progress. As another example, smart outdoor system 200 represents an operational swimming pool using a state describing a cleanliness of the swimming pool. In some embodiments, generating the digital representation includes identifying occlusions within the space. For example, smart outdoor system 200 identifies that a wall occludes a portion of a swimming pool within a frame of a camera view. In various embodiments, smart outdoor system 200 performs the method. For example, a processing device (e.g., comprising processor 204 and memory 206, etc.) may perform the method. In various embodiments, one or more steps of the method are split between a number of processing devices.

At step 410, smart outdoor system 200 may receive data associated with a context of an area. The data may include image data (e.g., video frames, etc.). For example, the data may include an image of a swimming pool located in a backyard space. Additionally or alternatively, the data may include other types of data such as pH data (e.g., from a swimming pool, etc.), temperature data, power consumption data (e.g., from a pool pump or pool heater, etc.), and/or the like. In various embodiments, the data is received from a device monitoring the area. For example, the data may be received from camera 202, backyard device 218, sensor 220 (e.g., a pH sensor, etc.), and/or the like. In various embodiments, the device is fixed in a single location (e.g., a pan-tilt-zoom security camera, etc.). Additionally or alternatively, the device may be dynamic (e.g., movable between a number of locations, etc.). For example, the device may include a camera coupled to a robotic pool skimmer.

At step 420, smart outdoor system 200 may receive an output from a routine that identifies a feature from the data. The output may be received from a remote processing device (e.g., the cloud, etc.), an internal model (e.g., an internal machine-learning (ML) model, etc.), and/or the like. For example, smart outdoor system 200 receives the output from a ML model trained using historical context data (e.g., labeled images of a swimming pool under different conditions, etc.). In various embodiments, the feature is associated with a characteristic of an entity in the area. For example, the entity may include a person and the feature may include an arm of the person (e.g., for pose estimation). As another example, the entity may include a person (e.g., a swimmer, etc.) and the feature may include a pose of the person. As yet another example, the entity may include a swimming pool and the feature may include a color of the swimming pool (e.g., for determining a cleanliness of the pool, etc.). As yet another example, the entity may include an object and the feature may include a movement of the object (e.g., for differentiating between a swimmer and a floating object, etc.). As yet another example, the entity may include an entity (e.g., a wall, a tree, etc.) and the feature may include a depth plane of the entity (e.g., for determining occlusions within a scene, etc.). In some embodiments, step 420 may include determining an identity of a person (e.g., performing facial recognition, etc.). For example, smart outdoor system 200 determines the identity of the person using a ML model trained with a database of users. In some embodiments, a user trains the model by inputting one or more images of an individual. For example, a user may train a ML model using a number of images of individuals expected

In various embodiments, the characteristic is a physical characteristic. For example, in a swimming pool context, the physical characteristic may include an activity of a person (e.g., whether a person is swimming vs. drowning, etc.). As another example, the physical characteristic may include a cleanliness of a pool. An entity may include physical structures, people, and/or physical objects. As a non-limiting example, an entity may include a pool, a pool deck, a robotic pool skimmer, construction equipment, a person, a pet, toys, plants, vehicles, debris, a storage shed, furniture, a grill, a robotic lawn mower, and/or the like. Entities may be related to/include other entities. For example, an entity representing a bucket of tools may include a number of additional entities representing each of the tools in the bucket. As another example, an entity representing an outdoor lawn chair may include another entity representing a cushion of the outdoor lawn chair.

In some embodiments, step 420 includes performing image segmentation (e.g., panoptic segmentation, etc.). For example, smart outdoor system 200 determines, for each pixel of an image of the received data, (i) a class describing a type of entity the pixel corresponds to and (ii) an instance of the type of entity the pixel corresponds to. For example, smart outdoor system 200 assigns a pixel a class (e.g., person vs. background, etc.) and an instance (e.g., a first person vs. a second person, etc.). Smart outdoor system 200 may differentiate between a number of classes. For example, smart outdoor system 200 differentiates between types of animal (dogs vs. cats, etc.), ages of person (e.g., toddler vs. child vs. adult, etc.), and/or types of object (e.g., toy vs. shovel vs. robotic pool skimmer, etc.). In some embodiments, smart outdoor system 200 selects a pixel (or a grouping of pixels, etc.) from the image as the feature. In some embodiments, selecting the pixel includes selecting a portion of a pixel (e.g., part of a feature, a sub-pixel location, etc.). In some embodiments, smart outdoor system 200 segments an image based on a depth plane associated with each pixel. For example, smart outdoor system 200 determines that a first pixel corresponding to a tree is associated with a first depth plane and a second pixel corresponding to a wall is associated with a second depth plane that is behind the first depth plane relative to a camera.

At step 430, smart outdoor system 200 may analyze the feature by at least one of (i) tracking the feature, (ii) correlating the feature with another feature, and/or (iii) correlating the feature with a previously classified entity. For example, smart outdoor system 200 tracks a water level within a pool over time. Tracking the feature may include executing an image tracking algorithm (e.g., Kalman tracking, optical flow method, Lucas-Kanade Algorithm, Horn-Schunck method, Black-Jepson method, etc.). For example, smart outdoor system 200 receives a frame, identifies foreground pixels and background pixels in the frame, and applies a Markov Random Field (MRF) algorithm to form one or more tracking blocks (e.g., clusters) to track one or more objects within the frame. As another example, the feature may include a pose of a swimmer and smart outdoor system 200 may track the pose of the swimmer over time to infer that the swimmer is swimming (e.g., to classify an activity of the swimmer, to classify an object as a swimmer, etc.). In some embodiments, tracking the feature includes identifying an occlusion associated with an image. For example, smart outdoor system 200 tracks an individual and determines when the individual becomes occluded by foliage. In some embodiments, identifying the occlusion includes receiving a user input (e.g., a user selection of the occlusion, etc.). In some embodiments, tracking the feature includes tracking a portion of a pixel (e.g., part of a feature, a sub-pixel location, etc.).

Correlating the feature with another feature may include correlating a first feature associated with an entity with one or more features of the same entity. For example, smart outdoor system 200 correlates a left arm of an individual with a right arm of the individual to determine a pose of the individual. As another example, smart outdoor system 200 correlates a pool color with a pH measurement to determine the cleanliness of a pool. Additionally or alternatively, correlating the feature with another feature may include correlating a first feature associated with a first entity with one or more features of one or more other entities. For example, smart outdoor system 200 correlates a color of leaves on a tree with a color of grass on a lawn to determine that the space requires watering.

Correlating the feature with a previously classified entity may include correlating the feature with a model that has been retrained using a previously classified entity. For example, smart outdoor system 200 classifies an object as debris, retrains a model representing a swimming pool area using the classified object, and correlates the debris with a color of a swimming pool to infer that the swimming pool is dirty. As another example, smart outdoor system 200 correlates a pool color (e.g., a feature) with an entity that was previously classified as a person to determine that the person is a pool cleaner.

In some embodiments, smart outdoor system 200 generates higher level classifications using lower level classifications. For example, smart outdoor system 200 combines (i) information from tracking a color of a pool over a period of time, (ii) information from identifying debris within a pool, and (iii) information from identifying an individual as a pool cleaner to determine a state of the swimming pool (e.g., clean status, etc.). Higher level classifications may be more abstract (e.g., a cleanliness status of a pool) while lower level classifications may be more specific individual components of a system (e.g., a color of water in a pool, etc.).

In various embodiments, step 430 includes generating a classification describing the characteristic of the entity. For example, smart outdoor system 200 classifies a portion of a lawn as “requiring watering.” The classification may depend on the entity being classified. For example, smart outdoor system 200 classifies a person based on an activity of the person (e.g., swimming, struggling, playing, etc.). As another example, smart outdoor system 200 classifies a swimming pool based on a condition of the swimming pool (e.g., clean/dirty, in-use/vacant, covered/uncovered, currently being serviced/available, etc.). As yet another example, smart outdoor system 200 classifies an object based on its identity (e.g., classify a moving object as a robotic pool skimmer, etc.). In some embodiments, the classifications include binary classifications (e.g., in-use/vacant, etc.). Additionally or alternatively, the classifications may include categorical classifications (e.g., 90% clean, finishes and fixtures construction phase, etc.). For example, in a construction context, smart outdoor system 200 generates a classification corresponding to a phase of the construction (e.g., layout/dig/steel, gunite shell, pregrade dirt, plumbing, tile, deck form/pour, electric, deck topping, screen, clean-out, plaster, etc.). In some embodiments, the phases of construction include (i) layout/design, (ii) excavation/dig, (iii) steel installation, (iv) plumbing/electrical, (v) shotcrete, (vi) tile/decking, (vii) interior finish, (viii) startup/backfilling, (ix) deck coating, and/or (x) landscaping. In some embodiments, the classification is associated with an event (e.g., a drowning event, etc.).

In some embodiments, step 430 includes identifying a node of a Markov model associated with the entity and generating the classification based on the node. For example, smart outdoor system 200 represents a state of construction progress for a swimming pool using a Markov model, identifies a node corresponding to a current phase of the construction progress, and generates a classification based on the current phase associated with the node. To continue the previous example, smart outdoor system 200 represents an initial phase of the construction using a first node, an intermediate phase of the construction using a second node, and a final phase of the construction using a third node. In various embodiments, smart outdoor system 200 identifies the node of the Markov model using one or more images of the construction site (e.g., a time-lapse, etc.).

In some embodiments, step 430 includes determining an orientation/position of an entity. For example, an entity may include a robotic pool skimmer and smart outdoor system 200 may generate a classification that includes a pose of the robotic pool skimmer. A pose may include an angle/orientation of the entity and/or the position of the entity (e.g., in X-Y-Z coordinates, pitch, yaw, and roll, etc.). In some embodiments, determining a pose of the entity includes performing image segmentation. For example, smart outdoor system 200 identifies an arm and a leg of an individual and determines a pose of the individual based on the position of the identified arm in relation to the identified leg. In some embodiments, the method includes transmitting the pose to a device. For example, smart outdoor system 200 determines a pose of a robotic pool skimmer and transmits the pose to the robotic pool skimmer (e.g., to enable the robotic pool skimmer to orient within a pool, etc.). Additionally or alternatively, smart outdoor system 200 may transmit other data to the device. For example, smart outdoor system 200 identifies a location of debris within a pool and transmits an instruction to a robotic pool skimmer that includes a location of the debris (e.g., to enable the robotic pool skimmer to locate the debris, etc.).

At step 440, smart outdoor system 200 may generate a representation of the area based on analyzing the feature. In various embodiments, the representation includes the classification of the entity. The classification may describe the characteristic of the entity. In various embodiments, the representation includes a digital representation of the area. For example, smart outdoor system 200 generates a digital twin of a backyard space. In some embodiments, step 440 includes determining a position of an entity. For example, smart outdoor system 200 identifies a 6-dimensional position of a robotic pool skimmer. Smart outdoor system 200 may determine an absolute position (e.g., X-Y-Z coordinates, pitch, yaw, roll, etc.) and/or a relative position (e.g., 10 feet from an edge of a swimming pool, etc.). In some embodiments, step 440 includes generating/updating a representation of the area that includes occlusion information. For example, smart outdoor system 200 updates a digital representation of a tree (e.g., an object semantically classified as a tree, etc.) to reflect that the tree is occluding a fence and a portion of a swimming pool. In some embodiments, occlusion information includes a boundary. For example, smart outdoor system 200 may generate a boundary in a camera image that corresponds to an area occluded by a tree limb. In some embodiments, the occludion information includes depth information (e.g., a depth plane, etc.).

In some embodiments, the method includes analyzing the representation of the area to generate one or more analytics. For example, smart outdoor system 200 generates analytics describing the frequency of usage of a backyard space. The analytics may be specific to each entity. For example, in a swimming pool context the analytics may include an evaporation factor (e.g., how much water evaporates from a pool over a certain time period, etc.), usage periods (e.g., what days/times a pool is occupied, etc.), a bather load (e.g., how many people have used a pool over a certain time period, etc.), a presence of pets (e.g., whether pets are currently in a pool, how many pets have been in the pool over a certain time period, etc.), information associated with a robotic pool skimmer (e.g., how long has the robotic pool skimmer been active over a certain time period, how much debris has the robotic pool skimmer collected over a certain time period, what is the cleanliness level of the pool, etc.), and/or the like. In various embodiments, the analytics are associated with (e.g., describe) an operational characteristic of a swimming pool. For example, the analytics may include a cost of operating a swimming pool (e.g., based on pool pump/heater power consumption, water replenishment, cleaning chemicals, etc.). In various embodiments, smart outdoor system 200 generates the analytics based on a classification. For example, smart outdoor system 200 classifies a pool as uncovered and, in response, updates an evaporation factor analytic (e.g., to account for increased evaporation, etc.). The analytics may include aggregate analytics (e.g., how frequently a space is used in general, etc.), entity analytics (e.g., how frequently a pool within a space is used, etc.), environment analytics (e.g., a temperature of a space over time, etc.), time-based analytics (e.g., a swimming pool is usually full from 1-2 pm on Fridays, etc.), feature-based analytics (e.g., a swimming pool is rated as 80% clean compared to a threshold, etc.), and/or the like. In various embodiments, smart outdoor system 200 presents the analytics to a user (e.g., via user interface 210, etc.).

In some embodiments, smart outdoor system 200 performs actions based on the analytics. For example, smart outdoor system 200 tracks a number of people that enter a swimming pool over a certain time period and triggers a robotic pool skimmer in response to determining that 1000 people have used the swimming pool since it was last cleaned.

Additionally or alternatively, smart outdoor system 200 may perform actions based on a classification of the entity. For example, smart outdoor system 200 classifies a swimming pool as requiring cleaning and, in response, triggers a robotic pool skimmer to clean the swimming pool. Triggering automated actions in this manner may be advantageous in a swimming pool context. For example, some spaces (e.g., hotels, etc.) may require a pool to be cleaned after every 500 swimmers, which may be difficult to track manually. However, smart outdoor system 200 may track a bather load and may automatically trigger cleaning at desired intervals, thereby facilitating compliance and reducing labor overhead. Moreover, some robotic pool skimmers may be battery powered, therefore continuously running the robotic pool skimmer may not be feasible. However, smart outdoor system 200 may trigger a robotic pool skimmer when it is needed, thereby reducing power consumption and extending the operational life of the robotic pool skimmer.

In some embodiments, the method includes predicting future states based on past/current states. For example, smart outdoor system 200 predicts that a pool temperature will rise based on determining that an outdoor temperature of the space is significantly higher than the current pool temperature. In various embodiments, smart outdoor system 200 may perform actions based on the predicted future states. For example, smart outdoor system 200 triggers automated pool cleaning in response to predicting that a pool will transition below a threshold cleanliness state in the next two hours. In various embodiments, an output from processing is used to update a model such as a ML model (e.g., to improve an accuracy of the model, etc.). For example, smart outdoor system 200 may update a digital-twin of a space using a classification associated with the space that was generated by a ML model.

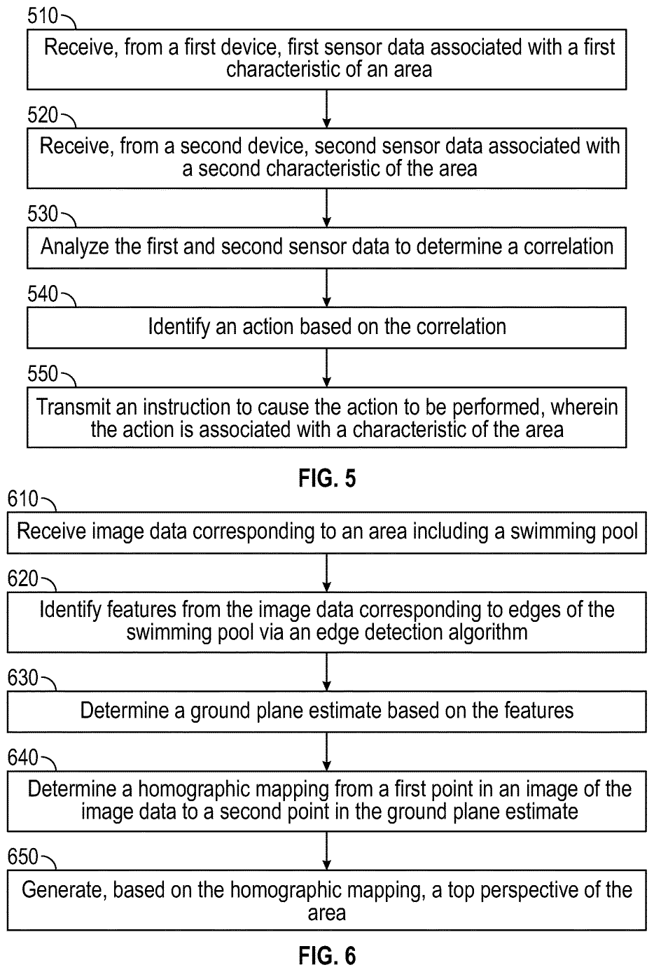

Referring now to FIG. 5, a method for controlling a space is shown, according to an exemplary embodiment. In various embodiments, smart outdoor system 200 may control a space such as a swimming pool area by performing automated actions. For example, smart outdoor system 200 transmits an instruction to a robotic pool skimmer to remove debris from a pool in response to detecting the debris using an object detection algorithm. As another example, in response to detecting an unauthorized individual (e.g., based on facial recognition, etc.) in an area under construction, smart outdoor system 200 transmits an instruction to a lighting system to cause a number of lights to turn on, thereby illuminating the area under construction (e.g., to scare off an intruder, etc.).

At step 510, smart outdoor system 200 may receive first sensor data associated with a first characteristic of an area. In various embodiments, smart outdoor system 200 receives the first sensor data from a first device. At step 520, smart outdoor system 200 may receive second sensor data associated with a second characteristic of the area. In various embodiments, smart outdoor system 200 receives the second sensor data from a second device. The first and second device may include a temperature sensor, a pH sensor (e.g., pH sensor 106A), a camera (e.g., camera 102), a robotic pool skimmer (e.g., robotic pool skimmer 104° C.), a pool pump (e.g., pool pump 106B), a pool heater, and/or the like. The first and second sensor data may include a status (e.g., an operational status of a pool pump or pool heater, a covered/uncovered status of an automatic pool cover, etc.), power consumption information (e.g., from a pool pump or a pool heater, a battery status of a robotic pool skimmer, etc.), a sensor reading (e.g., temperature information, pH information, etc.), operational information (e.g., a current position of a robotic pool skimmer, etc.), and/or audio-visual information (e.g., video from camera 102, etc.). For example, smart outdoor system 200 may receive an image from a camera and a pH measurement from a pH sensor.

At step 530, smart outdoor system 200 may analyze the first and second sensor data to determine a correlation. For example, smart outdoor system 200 determines a correlation between a color of pool water and a pH measurement of the pool water that is indicative of a need to clean the pool. As another example, smart outdoor system 200 determines a correlation between a time when sprinklers are operated in a backyard space and when a swimming pool requires cleaning (e.g., due to runoff from a lawn into the swimming pool caused by the sprinklers, etc.). In some embodiments, smart outdoor system 200 analyzes the first and second sensor data using a ML model. In some embodiments, the model is a pre-trained supervised model, deep learning model, an Artificial Neural Network (ANN) model, a Random Forest (RF) model, a Convolutional Neural Network (CNN) model, a Hierarchical extreme learning machine (HELM) model, a Local binary patterns (LBP) model, a Scale-Invariant Feature Transform (SIFT) model, a Histogram of gradient (HOG) model, a Fastest Pedestrian Detector of the West (FPDW) model, or a Stochastic Gradient Descent (SGD) model. Determining the correlation may include determining a state of the space (and/or entities therein). For example, smart outdoor system 200 determines whether a flowerbed requires watering. In various embodiments, an output from the ML model is used to update the ML model and/or another model (e.g., to improve an accuracy of the model, etc.). For example, smart outdoor system 200 may update a ML model using a classification previously generated by the ML model (e.g., to apply the tag “swimmer” to an object previously identified as a swimmer, etc.).

At step 540, smart outdoor system 200 may identify an action based on the correlation. For example, smart outdoor system 200 aggregates a number of low level characteristics (e.g., water color, pH measurements, etc.) to determine that a pool is dirty and, in response, identifies an action (e.g., causing a robotic pool skimmer to clean the pool, etc.). In various embodiments, the action is associated with a state of the space (and/or entities therein). For example, smart outdoor system 200 determines a correlation that is indicative of high levels of evaporation from a swimming pool and identifies an action that addresses the high levels of evaporation (e.g., causing an automatic swimming pool cover to deploy, etc.). In some embodiments, identifying the action includes executing one or more rules. For example, smart outdoor system 200 executes a rule that includes transmitting an instruction to a robotic pool skimmer to cause the robotic pool skimmer to capture debris anytime debris is detected within a swimming pool.

At step 550, smart outdoor system 200 may transmit an instruction to cause the action to be performed. For example, smart outdoor system 200 transmits an instruction to a robotic pool skimmer to cause the robotic pool skimmer to clean a swimming pool. As another example, smart outdoor system 200 transmits an instruction to an automatic awning system to cause the awning to deploy. As yet another example, smart outdoor system 200 transmits an instruction to a sprinkler system to cause the sprinkler system to operate (e.g., water a lawn, etc.). In various embodiments, the action is associated with a characteristic of the area. For example, smart outdoor system 200 determines that an unrecognized individual is in a backyard space and causes a sprinkler system to operate (e.g., to deter the unrecognized individual, etc.).

Referring now to FIG. 6, a method for generating an image for image tracking is shown, according to an exemplary embodiment. In various embodiments, smart outdoor system 200 performs homographic transformation on one or more images to change a perspective of the one or more images. For example, smart outdoor system 200 combines a number of images captured from security cameras (e.g., images having a two vanishing-point perspective, etc.) into a single composite image having a top perspective (e.g., a composite orthographic image, etc.). In various embodiments, smart outdoor system 200 uses the resulting composite image for image tracking. For example, smart outdoor system 200 performs image registration to form a combined image from two images having different viewpoints and performs image tracking using the combined image.

At step 610, smart outdoor system 200 may receive image data corresponding to an area. In some embodiments, the area includes a swimming pool. For example, smart outdoor system 200 receives an image from a camera (e.g., camera 102, etc.) that includes a view of the swimming pool. It should be understood that while FIG. 6 is described in relation to a swimming pool, the method of FIG. 6 may be applied for other areas (e.g., a construction area, an area under security monitoring, etc.). In various embodiments, the image data includes multiple images. For example, the image data may include a first image from a first camera and a second image from a second camera. In various embodiments, smart outdoor system 200 receives the image data from cameras disposed in an area around the swimming pool. Additionally or alternatively, smart outdoor system 200 may receive the image data from other sources (e.g., a data feed, an image library, a remote camera, etc.). For example, smart outdoor system 200 receives image data from a satellite imagery/aerial photography data source. As another example, smart outdoor system 200 receives image data from an aerial drone.

In various embodiments, the image data includes more than one image having at least partially overlapping views. For example, smart outdoor system 200 receives a first image having a view of half a pool and a yard space and receives a second image having a view of the entire pool (e.g., including the half of the pool in the first image). As another example, smart outdoor system 200 receives a first image from a camera disposed at a pool (e.g., camera 102, etc.) that includes a view of the pool and receives a second image from a satellite imagery data source that includes a view of the pool in context to the surroundings. As yet another example, smart outdoor system 200 receives a first image from a first camera (e.g., positioned to have a first view) and receives a second image from a second camera (e.g., positioned to have a second view that is different than the first view, etc.). As yet another example, smart outdoor system 200 receives a first image from a moving camera (e.g., a camera positioned on a drone or a robotic pool skimmer, etc.) at a first location and a second image from the moving camera at a second location. In some embodiments, the more than one image includes a scene having an entity. For example, the image data includes two images depicting a scene of a swimmer in a swimming pool. In some embodiments, the method includes preprocessing the image data (e.g., unwarping an image to account for lens distortion, etc.).

At step 620, smart outdoor system 200 may identify features from the image data corresponding to edges of the swimming pool via an edge detection algorithm. For example, smart outdoor system 200 applies an edge detection algorithm to identify one or more lines (e.g., features, etc.) corresponding to edges of the swimming pool. As another example, in a construction context, smart outdoor system 200 applies an edge detection algorithm to identify a number of features corresponding to a structure under construction. In various embodiments, the features include lines (e.g., lines between portions of concrete, lines around a perimeter of a pool, grout lines of tiling, etc.). The lines may include straight lines, curved lines (e.g., for non-rectangular pools, etc.), sharp corners, and/or the like. Additionally or alternatively, smart outdoor system 200 may identify any other feature that is shared between images. For example, smart outdoor system 200 identifies furniture that is located around the edge of the swimming pool. In some embodiments, step 620 includes applying an edge-detection algorithm. For example, smart outdoor system 200 may apply a low pass filter, Canny edge detection, Kovalevsky edge detection, a first-order difference operator (e.g., Sobel operator, Prewitt operator, etc.), a second-order difference operator (e.g., a differential approach, etc.), a phase stretch transform (PST) approach, and/or a subpixel approach (e.g., curve-fitting, moment-based, etc.). The edge-detection algorithm may include search based algorithms and/or zero-crossing based algorithms.

In some embodiments, the method includes identifying a number of pixels in the image data corresponding to a perimeter of the swimming pool based on the features. For example, smart outdoor system 200 generates a virtual fence (e.g., a virtual boundary defining an area such as a pool) based on identifying lines corresponding to an edge of the pool. Advantageously, generating a virtual fence may reduce an amount of time required to set up smart outdoor system 200 and/or may reduce errors associated with setup. For example, a user may manually define a virtual fence (e.g., by drawing the virtual fence on a user interface, providing dimensions on a user interface, etc.) and smart outdoor system 200 may compare the user generated virtual fence to an automatically generated virtual fence to suggest changes to a user, thereby reducing user errors in defining the virtual fence. As another example, smart outdoor system 200 automatically generates the virtual fence, thereby saving a user from having to manually define the virtual fence. In some embodiments, the method includes transmitting a recommendation of a perimeter of the swimming pool to a device associated with a user. For example, smart outdoor system 200 transmits a recommendation for a virtual fence to a user device to aid a user in correcting a manual selection during a setup process.

In some embodiments, the method includes determining a correlation between a first feature in a first image and a second feature in a second image. For example, smart outdoor system 200 determines that an edge in a first image corresponds to (e.g., is the same as, etc.) an edge in a second image and may warp the first image and/or the second image to match the edges. Determining the correlation may include generating a fundamental matrix describing a relationship between the first image and the second image. In some embodiments, determining the correlation includes determining a pose of an entity. For example, smart outdoor system 200 receives a first image of a pool having a first view of a swimmer, receives a second image of the pool having a second view of the swimmer, and correlates an arm of the swimmer from the first view with a leg of the swimmer from the second view to determine a pose of the swimmer.

At step 630, smart outdoor system 200 may determine a ground plane estimate based on the features. For example, smart outdoor system 200 calculates one or more vanishing points based on the identified features and generates a ground plane based on the one or more vanishing points. Calculating the one or more vanishing points may include an accumulation step and a search step. In the accumulation step, smart outdoor system 200 may cluster line segments (e.g., features, etc.) to generate a number of candidate vanishing points. In the search step, smart outdoor system 200 may identify a vanishing point from the candidate vanishing points by iteratively removing line segments corresponding to the accumulator cell (e.g., a Gaussian sphere centered on the optical center of the camera) having the maximum number of line segments passing through. In some embodiments, step 630 includes generating a fundamental matrix. For example, smart outdoor system 200 generates a 3×3 matrix with eight degrees of freedom based on the identified features. In some embodiments, step 630 includes generating a homography matrix.

At step 640, smart outdoor system 200 may determine a homographic mapping from a first point in an image of the image data to a second point in the ground plane estimate. For example, smart outdoor system 200 may determine the homographic mapping using a homography matrix generated in step 630. In various embodiments, the homographic mapping facilitates transforming a point on a first plane to a point on a second plane. For example, a homographic mapping is used to transform a point in an image from a first plane (e.g., a world plane, etc.) into a second plane (e.g., a ground plane estimate, etc.). In various embodiments, step 640 includes transforming a perspective of the image to conform to the ground plane.

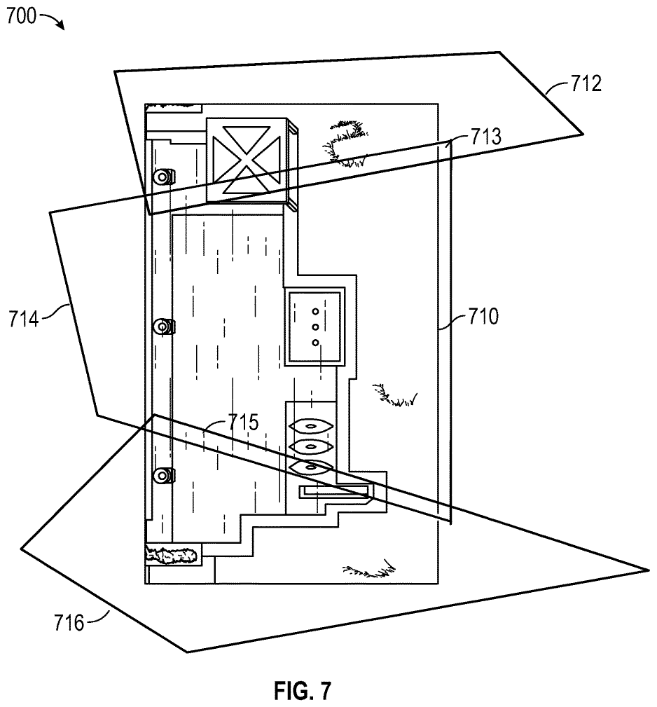

At step 650, smart outdoor system 200 may generate an aerial perspective (e.g., as shown in FIG. 7, below) of the area based on the homographic mapping. Generating the aerial perspective (e.g., a top-down view, a bird's-eye view, overhead view, etc.) may include translating an image, rotating an image, scaling an image, changing an aspect ratio of an image, and/or shearing an image. In various embodiments, step 650 includes applying the homographic mapping. For example, smart outdoor system 200 transforms a first point in the image to generate a second point according to the homographic mapping. In some embodiments, step 650 includes generating a mosaic (e.g., combination of two or more images, etc.). For example, smart outdoor system 200 projects a number of images onto a common plane to form a mosaic.

In some embodiments, the method includes combining a first image with a second image to form a composite image based on a correlation between features of the first image and the second image. For example, smart outdoor system 200 combines a first aerial image with a second ground-based image (e.g., from camera 102, etc.) based on a structure depicted within both images (e.g., as shown in FIG. 8). The composite image may be formed from synchronous and/or asynchronous sources. For example, smart outdoor system 200 generates a composite image from each frame of a first and second video feed generated by a first and second camera that are synchronized (e.g., a first frame from a first camera corresponds to the same point in time as a second frame from a second camera). In an asynchronous embodiment, smart outdoor system 200 may utilize the latest frame from each image source. In various embodiments, smart outdoor system 200 generates a composite image in real time (e.g., for each frame of a video feed, etc.). Additionally or alternatively, smart outdoor system 200 may generate a composite frame periodically (e.g., every minute, etc.) and/or in response to an event (e.g., a change in scene captured by the frame, etc.). Smart outdoor system 200 may track a pixel of the composite image using an image tracking algorithm. For example, smart outdoor system 200 tracks one or more pixels corresponding to an individual on a composite aerial image of a space surrounding a house. In some embodiments, smart outdoor system 200 applies tracking performed on a composite image (e.g., mosaic, etc.) to a number of images used to generate the composite image. For example, smart outdoor system 200 tracks a person using a composite image of an entire backyard space and may generate a user interface highlighting the tracked individual on a video feed from a camera having a partial view of the backyard space. Smart outdoor system 200 may use tracking information generated from the composite image to track an object across frames (e.g., track the individual from a first camera view into a second camera view, etc.).

Referring now to FIG. 7, orthomosaic image 700 is shown, according to an exemplary embodiment. Orthomosaic image 700 may depict a scene, shown here as swimming pool area 710. In various embodiments, smart outdoor system 200 generates orthomosaic image 700 to facilitate image tracking. Additionally or alternatively, smart outdoor system 200 may generate orthomosaic image 700 to display to a user (e.g., as described with reference to FIG. 8, below). In various embodiments, smart outdoor system 200 generates orthomosaic image 700 using two or more images. For example, smart outdoor system 200 may combine three images each having a different perspective into a single composite image having an aerial view. The two or more images may correspond to an outdoor space such as a backyard space. For example, smart outdoor system 200 generates orthomosaic image 700 using two images from a first and second camera 102. Additionally or alternatively, smart outdoor system 200 may generate an image having an aerial perspective from a single image. In some embodiments, orthomosaic image 700 is or includes a video. For example, smart outdoor system 200 generates orthomosaic image 700 for each frame of a video feed.

As shown, orthomosaic image 700 includes first image 712, second image 714, and third image 716. First image 712, second image 714, and third image 716 may be transformed versions of a first, second, and third image received from one or more cameras (e.g., camera 102, etc.). In various embodiments, smart outdoor system 200 generates orthomosaic image 700 as described with reference to FIG. 6 above. For example, smart outdoor system 200 (i) detects lines within one or more frames, (ii) generates a vanishing point based on the detected lines, (iii) generates a ground plane estimate based on the vanishing point, (iv) generates a homography estimate (e.g., a homography matrix, etc.) based on the ground plane, and (v) remaps the one or more frames to the ground plane based on the homography estimate. In some embodiments, smart outdoor system 200 generates orthomosaic image 700 using one or more overlapping (or at least partially overlapping) images. For example, smart outdoor system 200 combines first image 712, second image 714, and third image 716 using bi-linear interpolation to produce orthomosaic image 700 based on overlapping portions (shown as first overlap 713 and second overlap 715) of first image 712, second image 714, and third image 716. In various embodiments, smart outdoor system 200 compares features included in first image 712, second image 714, and third image 716 to align similar features in portions of overlap (e.g., first overlap 713 and second overlap 715) to produce orthomosaic image 700. For example, first overlap 713 may include a roofline of a gazebo and second overlap 715 may include an edge of a swimming pool and smart outdoor system 200 may manipulate first image 712, second image 714, and third image 716 to align the roofline of the gazebo and the edge of the swimming pool in first image 712, second image 714, and third image 716. Additionally or alternatively, smart outdoor system 200 may generate orthomosaic image 700 using non-overlapping images. For example, smart outdoor system 200 generates orthomosaic image 700 without second image 714 (e.g., such that there is a gap between first image 712 and third image 716, etc.).

Advantageously, by generating orthomosaic image 700 smart outdoor system 200 may improve a field of view/coverage of a space, thereby improving object detection and image tracking. Moreover, smart outdoor system 200 may incorporate orthomosaic image 700 into a user display to improve a user experience. For example, rather than having to switch between a number of camera views to monitor a person in an outdoor space as the person moves between the number of camera views, a user can monitor orthomosaic image 700.

Referring now to FIG. 8, composite image 800 is shown, according to an exemplary embodiment. Composite image 800 may include an aerial image merged with one or more additional images (e.g., orthographic images, etc.). For example, composite image 800 may include an aerial image combined with orthomosaic image 700. Composite image 800 may depict a scene such as an aerial image of a house and a space surrounding the house. In various embodiments, smart outdoor system 200 generates composite image 800 and/or displays composite image 800 to a user (e.g., via a user device, etc.). For example, smart outdoor system 200 displays composite image 800 to a user via a security system display to enable the user to visually track an individual walking around the user's house. In some embodiments, smart outdoor system 200 performs image tracking using composite image 800.

Smart outdoor system 200 may combine a first image with one or more additional images to generate composite image 800. For example, smart outdoor system 200 combines a first aerial image from an image source (e.g., image database, etc.), a second ground-based image from a first camera (e.g., camera 102, etc.), and a third ground-based image from a second camera (e.g., camera 102, etc.) to form composite image 800. Composite image 800 is shown to include camera views 810-814. Camera views 810-814 may correspond to a number of cameras disposed at the location (e.g., camera 102, etc.). In various embodiments, smart outdoor system 200 generates orthographic images 820-822 based on camera views 810-814. For example, smart outdoor system 200 generates orthographic image 820 using camera view 810 and camera view 812 as described with reference to FIG. 7 above.

In various embodiments, smart outdoor system 200 combines orthographic images 820-822 with an aerial image to form composite image 800 (e.g., such that orthographic images 820-822 overlay the aerial image, etc.). For example, smart outdoor system 200 correlates features between orthographic image 820 and an aerial image and generates composite image 800 based on the correlated features. Orthographic images 820-822 may be or include video. For example, smart outdoor system 200 transforms one or more video feeds (e.g., to generate an aerial perspective from the video feeds, etc.) and overlays the transformed video feeds onto an aerial image. In various embodiments, smart outdoor system 200 displays composite image 800 to a user. For example, smart outdoor system 200 may integrate with a security system and display composite image 800 via a display device of the security system.

Advantageously, by generating composite image 800, smart outdoor system 200 enables a user to intuitively contextualize a location of an entity. For example, a user may wish to view a person walking around an area using one or more cameras. However, the user may need to switch between the one or more camera views in order to view the person (e.g., as the person walks between camera views). While switching between camera views, the user may become confused as to which camera they are viewing (e.g., where the camera is physically located, etc.). However, by combining the views from the one or more cameras with an aerial image of the area, smart outdoor system 200 may enable a user to intuitively determine what camera they are viewing and/or may eliminate a need to change between camera views.

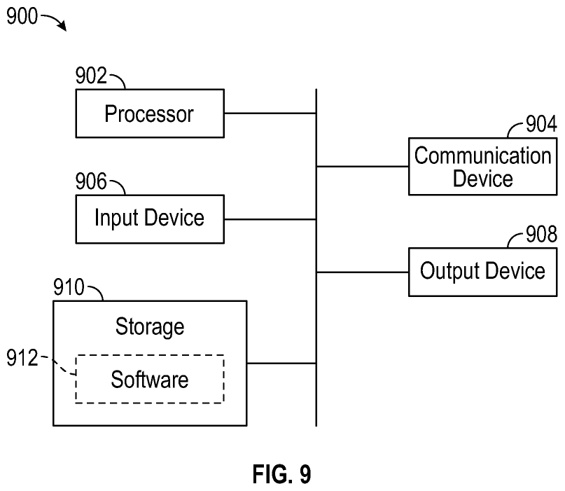

FIG. 9 illustrates an example of a processing device 900, in accordance with an embodiment. In some embodiments, the device 900 is configured to be coupled to the disclosed systems and is configured to perform the operational methods associated with the systems disclosed herein.

Device 900 can be a host computer connected to a network. Device 900 can be a client computer (e.g., a disclosed computing system), a server (e.g., a disclosed computing system), a portable device (e.g., alarm device 214), or a camera system (e.g., camera 102, camera 202, etc.). As shown in FIG. 9, device 900 can be any suitable type of microprocessor-based device, such as a dedicated computing device, a personal computer, work station, server, handheld computing device (portable electronic device) such as a smartwatch, phone, or tablet. The device can include, for example, one or more of processors 902, communication device 904, input device 906, output device 908, and storage 910. Input device 906 and output device 908 can generally correspond to those described above and can either be connectable or integrated with the computer.

Input device 906 can be any suitable device that provides input, such as a camera sensor, touchscreen, keyboard or keypad, mouse, voice-recognition device, or a user interface (e.g., user interface 210). Output device 908 can be any suitable device that provides output, such as an illuminator, a touchscreen (e.g., display 216), haptics device, or speaker.

Storage 910 can be any suitable device that provides storage, such as an electrical, magnetic, or optical memory including a RAM, cache, hard drive, or removable storage disk. In some examples, the storage 910 includes memory 206. Communication device 904 can include any suitable device capable of transmitting and receiving signals (e.g., streaming data) over a network, such as a network interface chip or device. The components of the computer can be connected in any suitable manner, such as via a physical bus, or wirelessly.

Software 912, which can be stored in storage 910 and executed by processor 902, can include, for example, the programming that embodies the functionality of the present disclosure (e.g., as embodied in the devices described above, a drowning detection program).

Software 912 can also be stored and/or transported within any non-transitory, computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 910, that can contain or store programming for use by or in connection with an instruction-execution system, apparatus, or device.

Software 912 can also be propagated within any transport medium for use by or in connection with an instruction-execution system, apparatus, or device, such as those described above, that can fetch instructions associated with the software from the instruction-execution system, apparatus, or device and execute the instructions. In the context of this disclosure, a transport medium can be any medium that can communicate, propagate, or transport programming for use by or in connection with an instruction-execution system, apparatus, or device. The transport readable medium can include, but is not limited to, an electronic, magnetic, optical, electromagnetic, or infrared wired or wireless propagation medium.

Device 900 may be connected to a network (e.g., an internal network, an external network), which can be any suitable type of interconnected communication system. The network can implement any suitable communications protocol and can be secured by any suitable security protocol. The network can comprise network links of any suitable arrangement that can implement the transmission and reception of network signals, such as wireless network connections, mobile internet connections, Bluetooth connections, NFC connections, T1 or T3 lines, cable networks, DSL, or telephone lines.

Device 900 can implement any operating system suitable for operating on the network. Software 912 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Systems and methods of the present disclosure may utilize one or more ML models. It should be understood that, while particular ML models may be used to describe some embodiments, any ML model may be used and all such recitations of particular ML models are meant to be non-limiting. For example, systems and methods of the present disclosure may implement a support vector machine, a regression model, a Bayesian network, a pre-trained supervised model, a deep learning model, an Artificial Neural Network (ANN) model, a Random Forest (RF) model, a Convolutional Neural Network (CNN) model, a Hierarchical extreme learning machine (HELM) model, a Local binary patterns (LBP) model, a Scale-Invariant Feature Transform (SIFT) model, a Histogram of gradient (HOG) model, a Fastest Pedestrian Detector of the West (FPDW) model, or a Stochastic Gradient Descent (SGD) model, and/or the like. In some embodiments, ML models utilize hardware accelerators. For example, a neural network may utilize a tensor processing unit (TPU) to increase a processing speed.

Generally, as used herein, the term “substantially” is used to describe element(s) or quantit(ies) ideally having an exact quality (e.g., fixed, the same, uniformed, equal, similar, proportional), but practically having qualities functionally equivalent to the exact quality. For example, an element or quantity is described as being substantially fixed or uniformed can deviate from the fixed or uniformed value, as long as the deviation is within a tolerance of the system (e.g., accuracy requirements, etc.). As another example, two elements or quantities described as being substantially equal can be approximately equal, as long as the difference is within a tolerance that does not functionally affect a system's operation.

Likewise, although some elements or quantities are described in an absolute sense without the term “substantially”, it is understood that these elements and quantities can have qualities that are functionally equivalent to the absolute descriptions. For example, in some embodiments, a ratio is described as being one. However, it is understood that the ratio can be greater or less than one, as long as the ratio is within a tolerance of the system (e.g., accuracy requirements, etc.).

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

The terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Particular embodiments may repeat one or more steps of the methods described herein, where appropriate. Although this disclosure describes and illustrates particular steps of methods as occurring in a particular order, this disclosure contemplates any suitable steps of the methods occurring in any suitable order. Moreover, it should be understood that while the methods of the present disclosure are described in relation to a number of steps, any number of suitable steps, including greater, fewer, and/or different steps are possible. Furthermore, although this disclosure describes and illustrates particular components, devices, or systems carrying out particular steps of the methods, any suitable combination of any suitable components, devices, or systems carrying out any suitable steps of the methods.

What is claimed is:

1. A method for monitoring a backyard space, comprising:
receiving, by a processing device, image data corresponding to a swimming pool area;
determining, by the processing device based on the image data, a state associated with a characteristic of the swimming pool area;
determining, by the processing device based on the state, a routine;
executing the routine; and
generating, by executing the routine, an analytic describing an operational characteristic of the swimming pool area, wherein the analytic is based on the state.

2. The method of claim 1, wherein determining the routine comprises determining a processing queue comprising the routine.

3. The method of claim 2, wherein determining the processing queue comprises:
sorting, by the processing device, a plurality of routines based on a processing overhead associated with each of the plurality of routines; and
assigning, by the processing device, each of the plurality of routines to a device for execution based on the associated processing overhead.

4. The method of claim 2, wherein determining the processing queue comprises assigning routines associated with monitoring safety at the swimming pool area to the processing device.

5. The method of claim 2, further comprising updating the processing queue in response to receiving an input.

6. The method of claim 5, wherein:
the input comprises an instruction for adding a second routine to the processing queue; and
wherein updating the processing queue comprises updating an order of the processing queue in response to receiving the instruction for adding the second routine.

7. The method of claim 2, wherein the processing queue includes a second routine and wherein an order of the routine and the second routine is determined based on the state associated with the characteristic of the swimming pool area.

8. The method of claim 1, wherein determining the state associated with the characteristic of the swimming pool area comprises determining whether the swimming pool area comprises a swimmer.

9. The method of claim 8, wherein determining whether the swimming pool area comprises the swimmer comprises determining whether an activity of the swimmer is a concerning event or a non-concerning event.

10. The method of claim 1, wherein the image data includes a plurality of frames of the swimming pool area, each of the plurality of frames having a different perspective and wherein determining the state associated with the characteristic of the swimming pool area comprises:
warping, by the processing device, each frame to produce a plurality of transformed frames, each of the plurality of transformed frames having a top view; and
combining, by the processing device, the number of transformed frames to produce a composite frame.

11. The method of claim 10, wherein executing the routine comprises tracking a portion of a pixel of a frame of the plurality of frames of the swimming pool area.

12. The method of claim 10, wherein combining the plurality of transformed frames to produce the composite frame comprises:
determining, by the processing device, a correlation between a first feature in a first frame of the plurality of transformed frames and a second feature in a second frame of the plurality of transformed frames; and
combining, by the processing device, the first frame and the second frame to form the composite frame based on the correlation.

13. The method of claim 10, wherein executing the routine comprises tracking a portion of a pixel of the composite frame using an image tracking algorithm. 14. The method of claim 1, wherein a second processing device executes the routine.

14. The method of claim 1, wherein the processing device operates on 10 watts or less.

15. The method of claim 1, wherein determining the state associated with the characteristic of the swimming pool area comprises determining the state in response to either (i) an input from a neural network trained via historic image data or (ii) a time-based trigger.

16. The method of claim 1, wherein determining the state comprises identifying, by the processing device, a node of a Markov model, and wherein the state corresponds to the node.

17. The method of claim 16, wherein the node of the Markov model includes a predetermined processing queue and wherein constructing the processing queue comprises constructing the processing queue from the predetermined processing queue.

18. The method of claim 17, wherein the node corresponds to a state of construction in the swimming pool area.

19. A system, comprising:
a video camera;
a processor and memory; and
a program stored in the memory, the program configured to be executed by the processor, and including instructions to cause the processor to:
receive image data corresponding to a swimming pool area;
determine, based on the image data, a state associated with a characteristic of the swimming pool area;
determine a processing queue including a routine based on the state;
cause a device to execute the routine; and
generate, by executing the routine, an analytic describing an operational characteristic of the swimming pool area, wherein the analytic is based on the state.

20. A non-transitory computer-readable storage medium having instructions stored thereon that, when executed by a processor, causes the processor to:
receive image data corresponding to a swimming pool area;
determine, based on the image data, a state associated with a characteristic of the swimming pool area;
determine a processing queue including a routine based on the state;
cause a device to execute the routine; and
generate, by executing the routine, an analytic describing an operational characteristic of the swimming pool area, wherein the analytic is based on the state.
